(19) United States
(12) Patent Application Publication
(10) Pub. No.: US 2013/0206700 A1
(43) Pub. Date: Aug. 15, 2013

(54) RADIAL FLOW COLUMN INCLUDING ZERO-VALENT IRON MEDIA

(71) Applicants: Chakravarthy S. Gudipati, Singapore (SG); Richard E. Woodling, Singapore (SG)

(72) Inventors: Chakravarthy S. Gudipati, Singapore (SG); Richard E. Woodling, Singapore (SG)

(73) Assignee: Siemens Pte. Ltd., Singapore (SG)

(21) Appl. No.: 13/838,773

(22) Filed: Mar. 15, 2013

Related U.S. Application Data
(63) Continuation-in-part of application No. 13/070,555, filed on Mar. 24, 2011.

(30) Foreign Application Priority Data
Mar. 25, 2010 (AU) 2010901265
Jun. 25, 2010 (AU) 2010902825

(51) Int. Cl. C02F 1/42; C02F 1/28

(52) U.S. Cl. CPC C02F 1/42; C02F 1/281
USPC 210/683; 210/283; 210/660

(57) ABSTRACT

Aspects and embodiments of the present disclosure are directed to apparatus and methods of filtering a fluid to reduce a level of at least one contaminant therein. The filtering of the fluid may be accomplished with a radial flow filtration column comprising a fluid chamber having an inlet, an outlet, and a side wall, an inner permeable retainer positioned in the fluid chamber, an outer permeable retainer positioned in the fluid chamber spaced apart from and surrounding the inner permeable retainer, a media bed compartment formed between the inner permeable retainer and the outer permeable retainer, a media bed comprising zero-valent iron disposed within the media bed compartment, and an adjustable element biased into the media bed compartment and configured to maintain a predetermined packing density of a media bed to be disposed within the media bed compartment.

### RELATED APPLICATIONS

This application claims the benefit under 35 U.S.C. §120 as a continuation-in-part of U.S. application Ser. No. 13/070,555, titled “RADIAL FLOW COLUMN,” filed on Mar. 24, 2011, which claims priority under 35 U.S.C. §119(a)-(d) or 35 U.S.C. §365(b) of Australian provisional application number 2010901265, filed Mar. 25, 2010, and Australian provisional application number 2010902825, filed Jun. 25, 2010 each of which is herein incorporated by reference in its entirety.

### FIELD OF THE DISCLOSURE

Aspects and embodiments of the present disclosure relate to methods and apparatus for water treatment using a radial flow column. In particular, aspects and embodiments of the present disclosure relate to methods and apparatus for removing selenium from contaminated water using a radial flow column. Some sources of selenium contaminated water include, for example, flue gas desulfurization wastewater from power plants, mining industry wastewater, and ground water.

### BACKGROUND

It is well known to treat water, for example, wastewater containing potentially harmful contaminants, by passing it through contaminant-removing filtration media (also referred to herein as “sorbent,” filter media,” or simply “media”) which has been packed into an elongate axial flow column. The contaminant-removing media forms a porous matrix through which the contaminated water flows. The path of the water is generally linear, along the axis of the filtration column with the downward flow of the water taking place under the force of gravity. As the contaminated water passes through the contaminant-removing media, contaminants in the water are removed. The contaminant-removing media may extract particular contaminants of interest via a number of different mechanisms such as absorption, adsorption, ion exchange, affinity, hydrophilic interactions, hydrophobic interactions, size exclusion, and other mechanisms known to those skilled in the art.

Axial flow columns are generally cylindrical and include an inlet at one end of the column and an outlet at the other. When used for commercial purposes, very large columns are sometimes required, with some commercial axial flow columns being, for example, as high as about six meters with a diameter of about three meters.

A problem can occur when increasing the throughput of an axial flow column. The combination of a high flow rate and a large bed height may result in a high pressure drop across the media. This may result in compression of the media which adversely affects the flow patterns through the column. In some areas, flow may be reduced almost to zero, while in other areas, compression of the media can result in the formation of channels in the media which facilitate the passage of contaminated water and greatly reduce the contaminant removal performance of the axial flow column.

One solution to the problems associated with axial flow columns is provided in U.S. Pat. No. 5,597,489, which discloses a radial flow column for water treatment. A radial flow column includes a fluid chamber which has cylindrical inner and outer screens positioned therein. A contaminant-removing media is packed in a media bed between the inner and outer screens. Contaminated water enters the column, and contacts the outer screen. The contaminated water then moves inward through the filtration media towards the inner screen where the treated water exits into the central lumen of the radial flow column. The filtered water can then be removed from the radial flow column through the central lumen.

FIG. 1 shows a longitudinal section of a radial flow column such as disclosed in U.S. Pat. No. 5,597,489. The outer casing 1 contains an outer mesh screen 2 and an inner mesh screen 3 and a filtration media 4 disposed between the inner and outer mesh screens. When viewed in a horizontal sectional plane, the filtration bed is annular in nature. The inner mesh screen 3 defines the lumen 5 of the device. Water enters the device at an inlet 6 and passes into the annular space 7 surrounding outer mesh screen 2. The water then passes through the outer mesh screen 2, filtration media 4, and inner mesh screen 3 before being taken off via the lumen 5 and exiting the device at the output 8.

In devices such as that illustrated in FIG. 1, any deficiencies in the filtration media, for example, variations in the packing density of the media from one portion of the media bed to another, can lead to the formation of channels in the media bed. These channels may be undesirable because they allow for the passage of contaminants through the filtration bed and directly into the treated water. This can result in contaminants being either discarded into the environment or, if the filtration device is being used for drinking water filtration, unknowingly consumed.

Additionally, the nature of the flow in radial flow columns is considerably more complex than those in simple axial columns and so, accordingly, there is a need in the art for a more rational basis on which to design and construct radial flow columns.

### SUMMARY

According to an aspect of the disclosure there is provided a radial flow column. The radial flow column comprises a fluid chamber having an inlet, an outlet, and a side wall, an inner permeable retainer positioned in the fluid chamber, an outer permeable retainer positioned in the fluid chamber spaced apart from and surrounding the inner permeable retainer, a media bed compartment formed between the inner permeable retainer and the outer permeable retainer, a media bed comprising zero-valent iron disposed within the media bed compartment, and an adjustable element biased into the media bed compartment and configured to maintain a predetermined packing density of the media bed.

In some embodiments, the inner permeable retainer and the outer permeable retainer are concentric.

In some embodiments the radial flow column further comprises an intermediate permeable retainer spaced apart from and surrounding the inner permeable retainer and spaced apart from and surrounded by the outer permeable retainer.

In some embodiments the radial flow column further comprises an inner flow chamber defined by an inner wall of the inner permeable retainer and having a first inlet at a first end of the inner flow chamber and a second inlet at a second end of the inner flow chamber.

In some embodiments the adjustable element is an inflatable bladder.

In some embodiments the adjustable element is a resiliently biased plunger.

In some embodiments the zero-valent iron is in the form of a powder.

In some embodiments the zero-valent iron powder has a particle size of less than about 100 μm.

In some embodiments particles of the zero-valent iron powder are coated.

In some embodiments particles of the zero-valent iron powder are coated with an iron-containing material.

In some embodiments particles of the zero-valent iron powder are coated with an oxide of iron.

In some embodiments particles of the zero-valent iron powder are coated with magnetite.

In some embodiments the media bed includes a first layer of media having a first composition and a second layer of media having a second composition different from the first composition.

In some embodiments the first layer of media includes the zero-valent iron.

In some embodiments the media bed includes a sorbent and a filtration aid.

According to another aspect of the disclosure there is provided a radial flow column. The radial flow column comprises a fluid chamber having a side wall, a first inner permeable retainer, a first outer permeable retainer surrounding the first inner permeable retainer and spaced apart from the first inner permeable retainer, a first media bed compartment formed between the first inner permeable retainer and the first outer permeable retainer, a second inner permeable retainer, a second outer permeable retainer surrounding the second inner permeable retainer and spaced apart from the second inner permeable retainer, a second media bed compartment formed between the second inner permeable retainer and the second outer permeable retainer and disposed axially inwardly of the first media bed compartment, and a media bed comprising zero-valent iron disposed within one of the first media bed compartment and the second media bed compartment.

According to another aspect of the disclosure there is provided a method of facilitating removal of selenium from a contaminated water stream. The method comprises providing a radial flow column. The radial flow column includes a fluid chamber having a side wall, an inner permeable retainer positioned in the fluid chamber, an outer permeable retainer positioned in the fluid chamber spaced apart from and surrounding the inner permeable retainer and defining an outer chamber between the outer permeable retainer and the side wall, a media bed compartment formed between the inner permeable retainer and the outer permeable retainer, a media bed comprising zero-valent iron disposed within the media bed compartment, an adjustable element biased into the media bed compartment and configured to maintain a predetermined packing density of the media bed, and a flow chamber defined by the inner permeable retainer.

According to another aspect of the disclosure there is provided a method of treating feed water containing selenium. The method comprises providing a source of feed water containing selenium and connecting the source of feed water to an inlet of a radial flow column. The radial flow column includes a fluid chamber having a side wall, an inner permeable retainer positioned in the fluid chamber, an outer permeable retainer positioned in the fluid chamber spaced apart from and surrounding the inner permeable retainer and defining an outer chamber between the outer permeable retainer and the side wall, a media bed compartment formed between the inner permeable retainer and the outer permeable retainer, a media bed comprising zero-valent iron disposed in the media bed compartment, an adjustable element biased into the media bed compartment and configured to maintain a predetermined packing density of the media bed, and a fluid flow passageway defined by the inner permeable retainer. The method further comprises passing the feed water from the inlet into the fluid flow passageway, passing the feed water radially outwardly from the fluid flow passageway through the media bed and into the outer chamber to produce decontaminated water, and removing the decontaminated water from the outer chamber.

In some embodiments treating the feed water containing selenium comprises passing feed water including up to about 2200 μg/L of selenium through the radial flow column with a hydraulic residence time of less than about 0.25 hours and removing substantially all of the selenium from the feed water.

In some embodiments the method further comprises removing boron and nitrates from the feed water with the zero-valent iron.

In some embodiments the feed water contaminants may also include, for example, arsenic (As), mercury (Hg), manganese (Mn), copper (Cu), cobalt (Co), cadmium (Cd), and/or other trace elements which may be at least partially removed by embodiments of a radial flow column as disclosed herein.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labelled in every drawing. In the drawings:

FIG. 1 shows prior art radial flow filtration column;

FIG. 2 shows an auto adjusting seal of an embodiment of the present disclosure for use in radial flow filtration columns;

FIG. 3 shows a radial flow filtration column including the auto adjusting seal of FIG. 1;

FIG. 4 is a close up of the auto adjusting seal of the radial flow filtration column of FIG. 3;

FIG. 5 shows an alternative auto adjusting seal according to another embodiment of the present disclosure for use in radial flow filtration columns;

FIG. 6 is a detailed illustration of a portion of the auto adjusting seal of FIG. 5;

FIG. 7 shows an alternative embodiment of a portion of the auto adjusting seal of FIG. 5;

FIG. 8 shows a radial flow filtration column including the auto adjusting seal of FIG. 5;

FIG. 9 shows the effect of packing densities and media composition on pressure drop for a given filtration flow rate in an embodiment of a radial flow filtration column of the present disclosure;

FIG. 10 shows the effect of packing densities and media composition on mercury removal performance in an embodiment of a radial flow filtration column of the present disclosure;

FIG. 11 shows a top-down cross-sectional view of an alternative radial flow filtration column of the present disclosure;

FIG. 12 shows a cross-sectional view from the side of the radial flow filtration column of FIG. 11;

FIG. 13 illustrates a cross section of a media bed in accordance with an embodiment of the present disclosure;

FIG. 14 shows a further alternative radial flow filtration column of the present disclosure;

FIG. 15 shows a schematic of a radial flow filtration column of an embodiment of the present disclosure with a centrifugal (CF) or inside-out (I-O) flow configuration;

FIG. 16 are comparative charts showing media bed utilization in an inside-out (I-O) flow type radial flow filtration column and an outside-in (O-I) flow type radial flow filtration column;

FIG. 17A is a perspective view of a radial flow filtration column in accordance with an embodiment of the present disclosure;

FIG. 17B is a side view of the radial flow filtration column of FIG. 17A;

FIG. 17C is an end view of the radial flow filtration column of FIG. 17A;

FIG. 18A is a cross-sectional view of the radial flow filtration column of FIG. 17A;

FIG. 18B is a perspective view of a first media bed retainer;

FIG. 18C is a perspective view of a second media bed retainer;

FIG. 19A is a partially exploded view of the radial flow filtration column of FIG. 17A;

FIG. 19B is a partially exploded view of internal components of the radial flow filtration column of FIG. 17A;

FIG. 20 is a graph illustrating copper removal performance versus flow rate for a radial flow filtration column in accordance with an embodiment of the present disclosure and for a prior art axial flow column;

FIG. 21 is a graph illustrating of filtration flow rate with different types of resin for a radial flow filtration column in accordance with an embodiment of the present disclosure and for a prior art axial flow column;

FIG. 22A is a graph illustrating long term performance with regard to mercury removal for a radial flow filtration column in accordance with an embodiment of the present disclosure and for a prior art axial flow column;

FIG. 22B is a graph illustrating long term performance with regard to arsenic removal for a radial flow filtration column in accordance with an embodiment of the present disclosure and for a prior art axial flow column;

FIG. 23 is a graph illustrating the increased filtration capacity of a radial flow filtration column in accordance with an embodiment of the present disclosure as compared to an exemplary axial flow column;

FIG. 24 is a table of experimental parameters and results for testing of selenium removal from a high TDS solution in a radial flow column;

FIG. 25 is a table of experimental parameters and results for testing of boron and nitrate removal data from a high TDS solution in a radial flow column;

FIG. 26A is a table of experimental parameters and results for long-term feasibility testing of selenium removal from a low TDS solution in a radial flow column;

FIG. 26B is another table of experimental parameters and results for long-term feasibility testing of selenium removal from a low TDS solution in a radial flow column; and

FIG. 26C is another table of experimental parameters and results for long-term feasibility testing of selenium removal from a low TDS solution in a radial flow column.

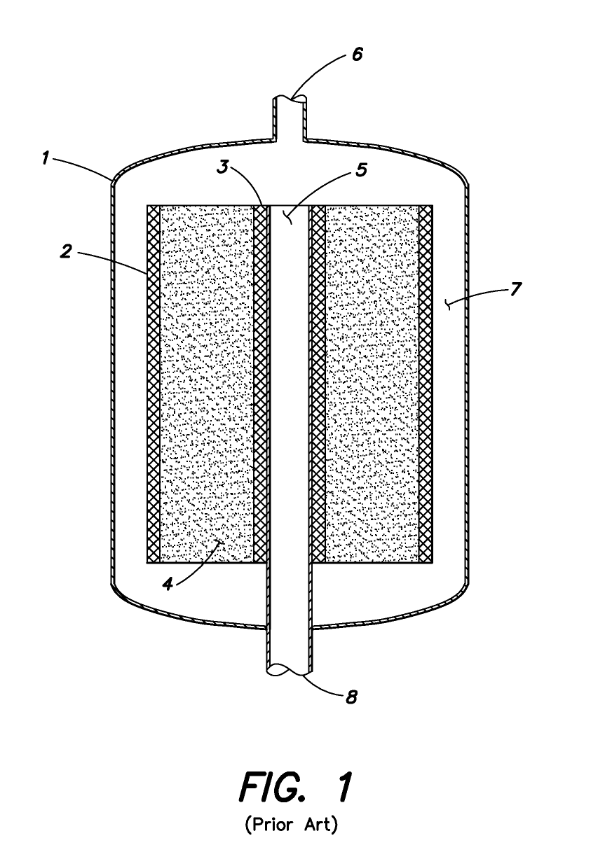

### DETAILED DESCRIPTION

This disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including,” “comprising,” “having,” “containing,” “involving,” and variations thereof herein is meant to encompass the items listed thereafter and equivalents thereof as well as additional items.

Radial flow filtration columns (referred to herein as “radial flow columns”) are extremely promising for the filtration of contaminants from water. It is, in some implementations, desirable that channels do not form through the media bed in a radial flow column. Channels can allow contaminants to flow with little or no intimate contact with the media directly into the take-off stream. Channels can form through the loss or settling of media. Media can leak out of a screen containing the media after the media is packed, during shipping of a packed media bed, or during use.

Alternatively, a reduction in bed volume can arise due either to gravity, where the particles of media condense at the bottom of a radial flow column, or due to the washing out of smaller particles or media, for example, particles of media having a diameter about equal to or smaller than a mesh size of a screen containing the media bed. Reduction in bed size may take place over a fairly long operational time, for example, over the course of about one year. The loss of media may occur without being noticed. The loss of media may result in the formation of channels in the media bed, which may facilitate the passage of contaminants such as mercury or other hazardous contaminants through the media bed and into the treated stream without proper treatment.

While bed volume can be lost by attrition as described above, it is also possible for the media to expand during use.

If the radial flow column has a fixed head, then the settling of the bed can give rise to fluid flow channels above the top of the bed which, if not blocked, can readily allow the passage of contaminants into the filtered fluid.

Some aspects and embodiments of the present disclosure prevent or reduce the amount of untreated fluid, for example, water, which channels through a media bed and into the treated fluid stream of a radial flow column due to media loss.

Embodiments of the present disclosure may be used for various purposes. For example, some embodiments of the present disclosure may be used for the remediation of industrial wastewater, while other embodiments may be used to remove contaminants from waste water or from ground water to produce potable or drinkable water. Other embodiments may be used in polishing operations for high purity water purification systems, and other embodiments may be used to produce high purity water for laboratory use. Embodiments of the present disclosure may use various forms of filtration media to accomplish the goals associated with the purpose for which the embodiments are used for. Some examples of media that may be used in different embodiments of the present disclosure include granular ferric oxide (GFH) media, activated carbon, ion-exchange resin, steel wool (zero-valent iron), bio-active media comprising bacterial agents, and any other filtration media or resin. The media may comprise particles with substantially regular shapes (e.g., spheres), irregular shapes, or a mixture of both.

In some embodiments, media comprising zero-valent iron (hereinafter Fe(0) or “ZVI”) may be provided as small particles or as a powder. In some embodiments, the ZVI powder may have an average particle size of less than bout 100 μm, for example, less than about 90 μm or less than about 45 μm. The ZVI media particles may, in some embodiments, be coated to enhance the contaminant removal efficiency of the media. As used herein, the term “coated” may include “having an outer layer at least partially covered with,” or “having an outer layer chemically or electrochemically converted to include.” In some embodiments, it has been found beneficial to coat the ZVI particles with an iron-containing material, for example, an iron oxide. The ZVI media particles may, in some embodiments, be coated with a layer of magnetite.

In some embodiments a layer of magnetite is coated on to the ZVI particles by chemically or electrochemically converting the outer layer of the ZVI particles as a conditioning step to maintain the activity of the ZVI during the process of treating wastewater. The removal of contaminants, for example, selenium from wastewater may include the reduction of the high oxidation state of the selenium (+6, +4, etc.) to insoluble elemental selenium by the ZVI. The elemental selenium (or other contaminant) may then be adsorbed to the ZVI media. The reduction of selenium and other contaminant elements may involve electron transfer from the ZVI to the target element. Without being bound to a particular theory, an example of a reduction to reaction of, for example, selenium may occur according to the following reaction:

SeO₄²⁻+2Fe(0)+Fe²⁺→Se(0)+Fe₃O₄

Over time, the conversion of the ZVI to iron oxides and/or the accumulation of contaminants adsorbed on the surface of the media particles may render the media less effective at removing contaminants from wastewater than fresh media. In some embodiments, the concentration of one or more contaminants in treated water exiting a radial flow column may be monitored and when this concentration exceeds a desired level, the media in the radial flow column may be replaced with fresh media.

The magnetite layer is coated on the ZVI particles so as to facilitate the electron transfer from the ZVI to the target contaminant element(s). Magnetite, with a small band gap between the valence and the conductance band, is a good electron carrier and therefore facilitates the reduction of the target element by electron transfer from ZVI to the contaminant(s). The magnetite layer coated on the ZVI may also passivate the ZVI and facilitate prevention of oxidation of the ZVI. The magnetite coating may in some embodiments be very thin, for example, in a range of from about a monolayer to about a micron in thickness.

In some embodiments where ZVI is used as a contaminant removal media, wastewater to be treated may be dosed with chemicals to increase a concentration of Fe²⁺ ions in the wastewater prior to, or during contact of the wastewater with the ZVI media. The Fe²⁺ ions may facilitate maintaining the ZVI media in an active magnetite state and prevent substantial oxidation of the ZVI media to inactive oxides. Without being bound to any particular theory, an example of a reaction between the Fe²⁺ and the ZVI may include the following reaction:

2γ-FeOOH+Fe²⁺→Fe₃O₄+2H⁺

The Fe²⁺ ions may be introduced in the form of FeCl₂ or FeSO₄ stock solutions at a set flow rate to maintain the concentration of Fe²⁺ ions in the wastewater coming into contact with the ZVI media in a range of, for example, between about 5 mg/L to about 50 mg/L. In some embodiments where the wastewater is contaminated with Ni which is to be removed, lower Fe²⁺ dosages may be utilized, for example, dosages sufficient to maintain the concentration of Fe²⁺ ions in the wastewater coming into contact with the ZVI media in a range of, for example, between about 0 mg/L to about 5 mg/L. The desired concentration of Fe²⁺ may be dependent upon the concentration and type of contaminants in the wastewater which are desired to be removed. If more than a desired amount of Fe²⁺, for example, more than is needed to reduce a desired amount of the contaminant ions and maintain the ZVI in an active state, is added to the wastewater to be treated excess Fe²⁺ in the wastewater, from dosage as well from in situ generation, will exit the media bed. In some embodiments the effluent of a radial flow column or fluidized bed reactor including the ZVI media may be monitored for the soluble iron levels and the dosage of Fe²⁺ may be adjusted until the concentration of soluble iron in the effluent drops below a desired threshold level.

Although embodiments of the disclosure are illustrated herein with reference to a screen to retain the media bed, it will be appreciated that any sort of permeable retainer can be used to retain the media bed while permitting the flow of fluid in and out of the media bed. In different embodiments, the permeable retainer may be a mesh, a frit, a membrane, a woven or non-woven fabric, a porous ceramic, or other suitable material. For example, in some embodiments, the permeable retainer comprises a polymeric membrane. The polymeric membrane, in some embodiments, has an effective pore size of about 10 μm, and in other embodiments an effective pore size of about 20 μm. In other embodiments, the permeable retainer is a screen, for example, a 5-layer stainless steel screen. In some embodiments the metal screen has a thickness of between about 1 mm and about 3 mm, for example, about 1.7 mm, and a pore size of between about 10 μm and about 30 μm. In other embodiment, the permeable retainer is a plastic screen. In some embodiments the plastic screen has a thickness of between about 3 mm and about 7 mm, for example, about 4 mm, and a pore size of between about 10 μm and about 30 μm.

In various embodiments of the present disclosure, a device is provided in contact with the media bed to apply a pressure to the media bed and reduce the likelihood of the formation of channels. The device may compact the media bed to counter the reduction in volume that would accompany the loss of media by, for example, escape of small particles of media through a screen retaining the media bed.

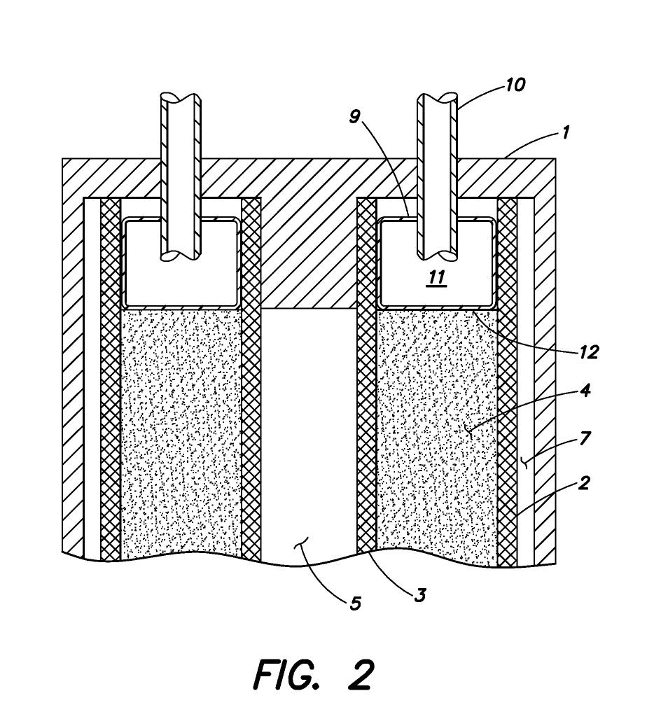

In one embodiment, as shown in FIG. 2, there is provided an inflatable bladder 9 positioned at the top of a media bed 4 in an annular flow column. When the space between the inner 3 and outer 2 screens is initially filled with media 4, the bladder 9, which in some embodiments is shaped annularly, is positioned on top of or adjacent to the top of the media bed 4. Alternatively, the bladder can be retrofitted to existing columns. The bladder can be inflated, by way of air pressure or by the introduction of a pressurized fluid, for example, water, oil, or pneumatic fluid, through conduit 10 into the cavity 11 of the bladder 9. The inflation of the bladder causes the bladder to press down upon the top 12 of the bed, thereby sealing the space between the inner and outer screens and ensuring that any flow between the inner and outer screens is through the media bed. The bladder will inflate to fill the void at the head of the space between the inner and outer screens above the media. Additional compressed air or fluid can be placed inside the bladder to maintain a desired packing pressure in the media bed and/or such that further expansion of the bladder is possible in response to compaction or loss of media from the media bed. In this way the bladder automatically fills any voids formed as the media compresses. The bladder may be maintained at a pressure which provides for at least partial compaction or at least partial deflation of the bladder should the media in the media bed expand. In some embodiments, multiple bladders 9 may be used in a single column. The multiple bladders may be arranged, for example, annularly about an end of the media bed. The bladder or bladders may be formed from, for example, rubber, plastic, or any other material that would inflate under application of pressure internal to the bladder(s). In some embodiments the bladder or bladders are formed from a metal shaped into an accordion-like structure which expands upon the application of pressure internal to the bladder(s).

In some embodiments, inflatable bladders can accommodate up to about 5% or up to about 10% of media loss by way of expansion, which is a fairly substantial amount of media loss. For example, in some instances, proper sieving of media of less than about 90 μm may take place prior to packing of a media bed where the permeable retainer is a frit or screen with a pore size of about 20 μm. As such, there would be little media sized smaller than the pore size of the frit or screen that could escape therethrough.

In some embodiments, a constant working pressure of between about 1.4 bar and about 2 bar between the influent and the filtrate is used during the radial filtration process. In some embodiments a higher pressure than the working pressure is applied to the inside of the bladder. In some embodiments a pressure of between about 3.5 bar and about 4 bar is applied and pumped into the bladder to push the media down and to keep it compact to prevent channeling. Having an overpressure in the bladder facilitates resistance to deformation of the bladder by the liquid being filtered.

In some embodiments, the bladder is relatively easy to maintain. It can be checked every few months, and by having a pressure gauge on both the influent waste water and the bladder, for example internal to the bladder, a user will be able to determine whether there is a leak in the system or whether it is desirable to pump in any more air or fluid into the bladder. Use of the bladder reduces or eliminates the need to open up the column and refill with media as a result of media loss.

Because the bladder is flexible, it can conform to the shape of the media bed when it is inflated, self adjusting to any irregularities. In some embodiments the bladder or bladders continue to conform to the shape of the media bed and fill up any gaps which are left behind by the loss of the media.

The bladder of the present disclosure is also useful in showing whether or not the media is correctly packed to the desired density. For example, if it is possible to pump in additional air or fluid below a certain pressure into the bladder immediately after the bed has been packed, this can be an indication of inadequate packing of the bed.

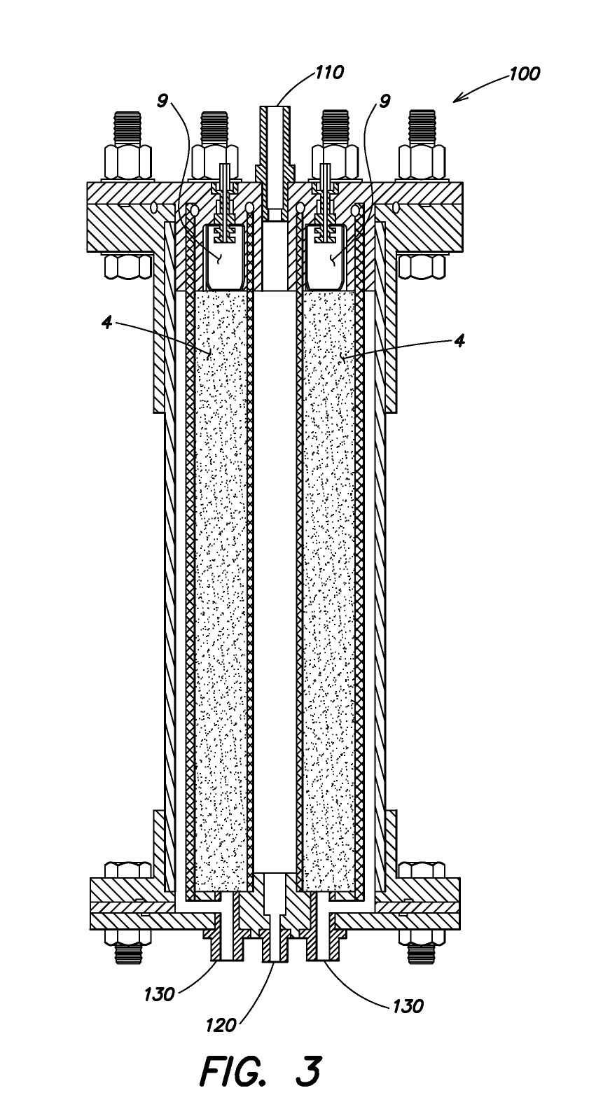

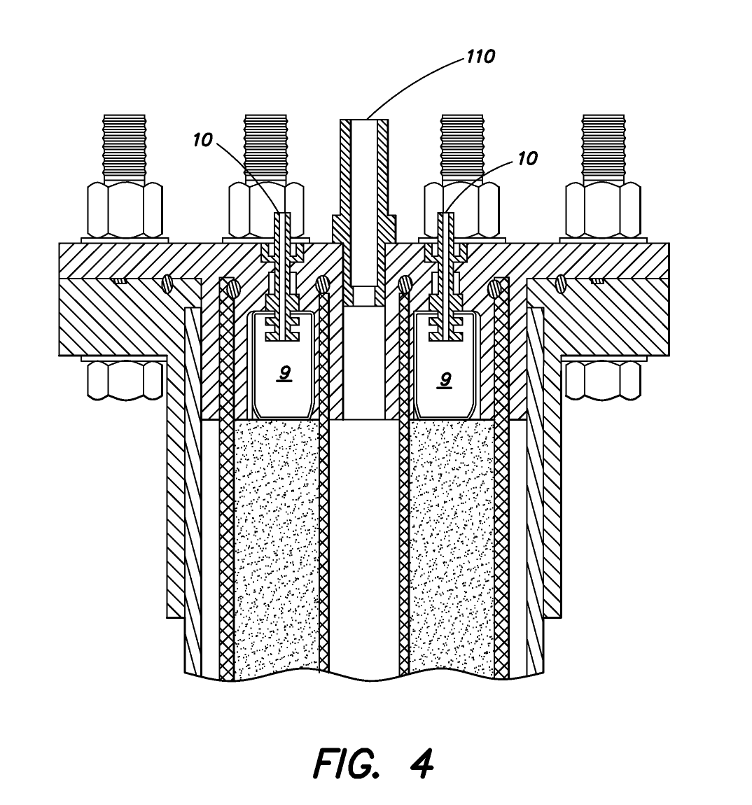

A radial flow column 100 including a bladder 9 as described above is illustrated in FIG. 3. The radial flow column 100 includes an upper fluid inlet 110, and a lower fluid inlet 120 in fluid communication with a centrally located lumen. The radial flow column also includes two filtered fluid outlets 130. A close-up of the upper end of the radial flow column 100 of FIG. 3 is illustrated in FIG. 4 wherein air conduits 10 for introducing air into the bladder 9 are more clearly visible.

In other embodiments the bladder 9, or one or more additional bladders, may be placed at an alternate location, for example, proximate the center or the bottom of the annular flow column media bed.

In some embodiments, a compressible resilient material may be used in conjunction with, or as an alternative to the bladder 9 to provide a compressive force to the media bed. For example, a portion of a compartment for retaining a filtration media may contain a mass of resilient material, for example, foam rubber. Upon addition of filtration media to the compartment, the resilient material compresses and exerts a force on the filtration media which reduces or eliminates the likelihood of the formation of channels in the media due to, for example, loss of media from the media bed. In other embodiments any system which can provide a controlled compressive force on the media bed may be used to compact or and/or pressurize the media bad to reduce the formation of channels.

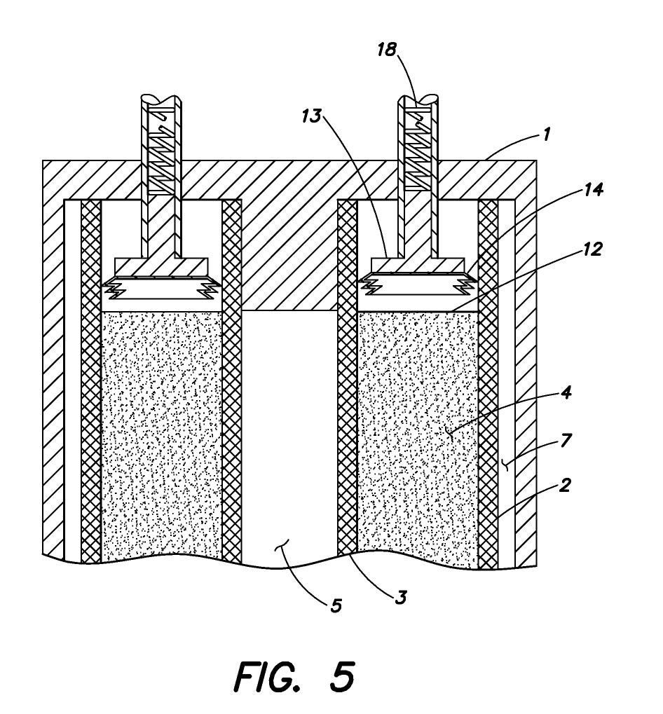

For example, in an alternative embodiment, shown in FIG. 5, a series of resiliently biased (for example, spring-loaded) scrubbing elements are utilized to scrub the inner surface of the screen and to pack the media to a desired density. Typically when there is media loss in a radial flow column, the lost media has a tendency to congregate around and clog the O-rings (not shown) which are used to seal the various sections of the device. The alternative space filler of the present disclosure uses a resiliently biased piston 13 equipped with a scrubber 14 to clean the material from the screen and to compact the surface of the bed. The scrubber comprises a portion which is configured to dislodge media from the walls of the screen. This portion may be shaped in any manner such that it contacts the walls of the screen as the plunger moves into and out from the media bed compartment. Some embodiments of a scrubber in accordance with the present disclosure employ a series of sequential wipers or scrapers 15, 16, 17, each one having a smaller clearance with respect to the screen than the previous wiper. For example, a lowermost wiper 15 has 1 mm clearance with the screen walls, the next wiper 16 has a 0.5 mm clearance and the uppermost wiper 17 has no clearance, that is the uppermost wiper 17 substantially or exactly conforms to the profile bound by the screens. Embodiments of the present disclosure are not however, limited to wipers having these, or any particular to clearances. Furthermore, in some embodiments more or fewer than three wipers may be present on the scrubber 14. For example, in some embodiments, the scrubber 14 includes only a single wiper, and in other embodiments, the scrubber 14 includes 4 or more wipers.

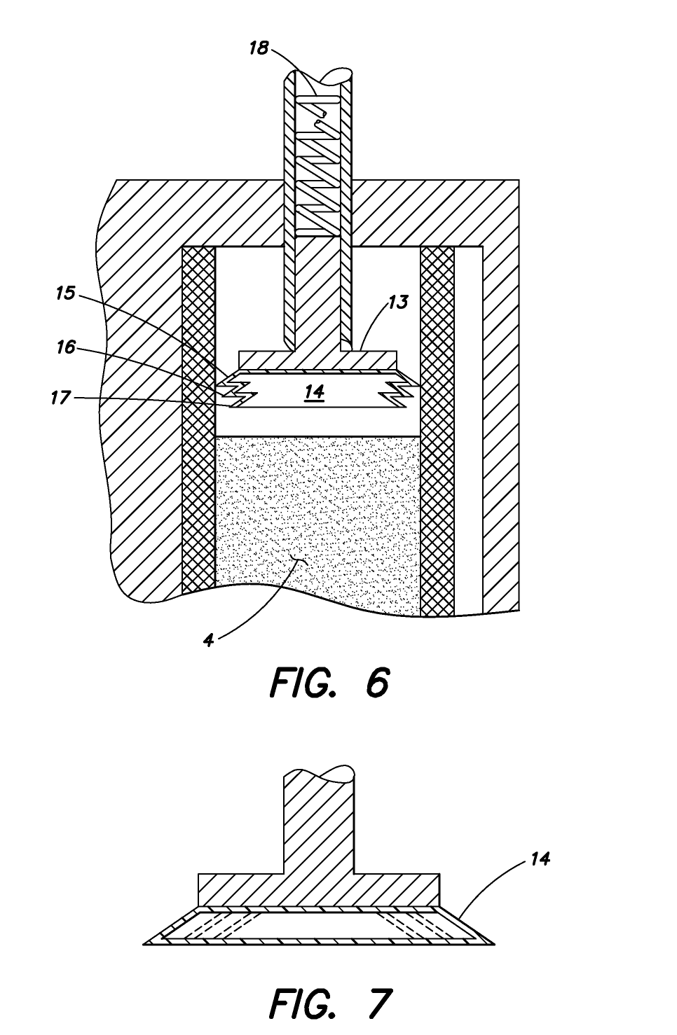

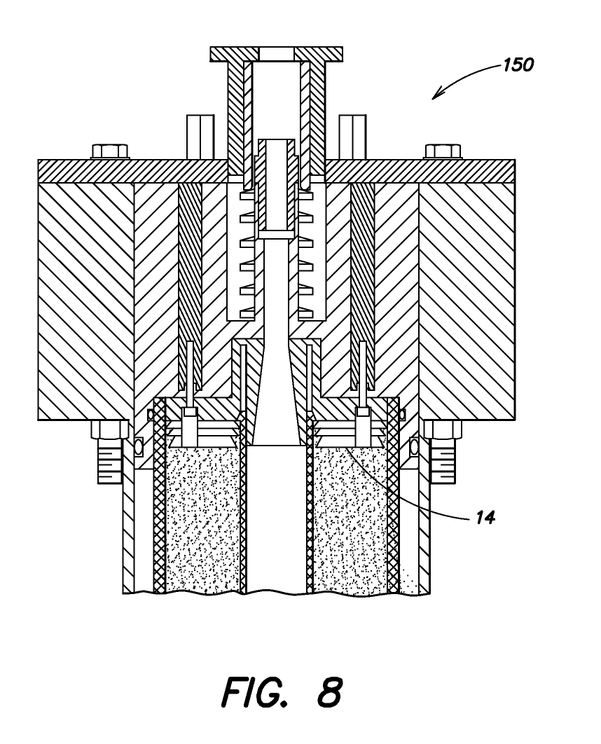

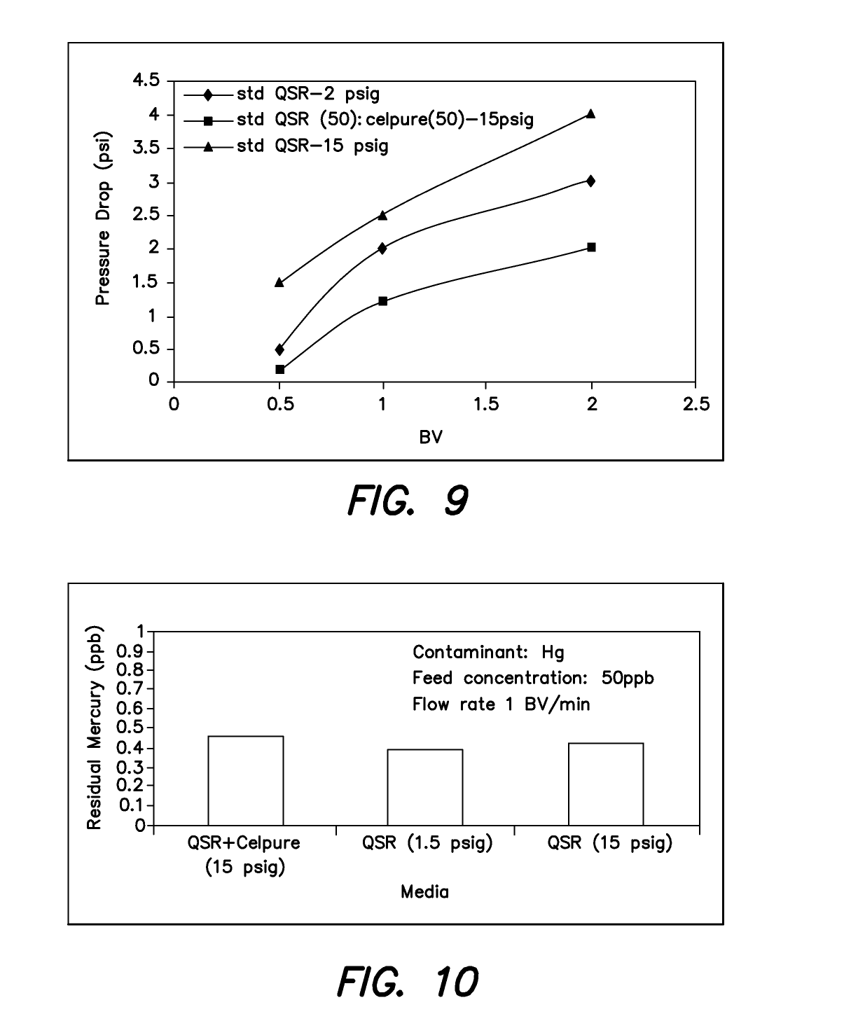

In some embodiments, the scrubber 14 is downwardly biased by a spring 18. The scrubber may move downward under the action of the spring upon loss of media from the column, or upward upon swelling of the media. As the scrubber 14 moves downward through the area between the screens 2, 3, it dislodges particles, for example, media, adhered to the screen and pushes the particles downward. The scrubber 14 pushes the larger particles down first, then medium sized particles, and finally by the time the third scrubbing element is in contact with the screens, the very smallest particles will be pushed down. FIG. 6 shows this arrangement in more detail. FIG. 7 shows a tightly compressed scrubber, which includes essentially a single scraper element. FIG. 8 illustrates a radial flow column 150 with an annular scrubber 14 disposed above a media bed. In other embodiments, alternative or additional mechanisms may be used to downwardly bias the scrubber 14. For example, the scrubber 14 may be biased downward by a pneumatic piston, by a solenoid, or gravitationally by a weight placed atop a piston on which the scrubber 14 is mounted.

The use of a scrubber 14 as described above has proved very satisfactory for pushing media on the side walls or the screen 2, 3 back to the media bed, providing a constant bed packing density. Since most of the dislodged media in the head space is generally trapped on the side walls of the screens 2, 3, embodiments of the present disclosure remove those particles and will prolong the life of the O-rings in the device. Further, it will prevent the apertures in the frit or screen from being permanently closed by blockage with the loose media.

In another embodiment of the present disclosure, there is disclosed a method for filling a radial flow column with small media particles. It will be appreciated that any suitable media can be used in the radial flow columns of the present disclosure.

Columns containing small media particles, for example, media particles having an average diameter in the range of from about 20 μm to about 200 μm are capable of operating with better kinetics than similar columns containing larger media to particles due to, for example, the larger surface are of the media particles. Materials with low permeability characteristics can be difficult to handle if they are not carefully packed. The packing pressure of the media is important, and can be selected based upon the media used and the intended use of the column. For example, it may be desirable to use a higher packing pressure for smaller media than for larger media to reduce the potential for the formation of channels in a media bed with smaller media, which may be operated at a higher pressure drop than a similar media bed with larger media. When media with low permeability characteristics is used in radial flow columns in accordance with embodiments of the present disclosure, the packing density can be carefully controlled and full packing can be achieved even at about 1 psig to about 2 psig packing pressure. In some embodiments, the radial flow column is packed with media with a packing pressure of between about 1 psig and about 3 psig. Any suitable pressure can be used. For example, the packing pressure may be less than 25 psig, or it may be in excess of 25 psig.

In some embodiments, the packing pressure is achieved by filling the media bed under a pressurized atmosphere at a predetermined desired pressure.

In some embodiments, the media of interest is supplemented with one or more filtering aids. Filtering aid materials may reduce the density of the media bed, providing for increased filtration flow rates with lower pressure drops. The filtering aid material(s) may include materials with a lower density and/or a greater particle size than the media to which they are added. In other embodiments, the filtering aid material(s) may have particle sizes about equal to or smaller than the media to which they are added. The distribution of particle size of a filtering aid material may be greater or less than a distribution of particle size of a media to which it is added. The filtering aid materials may be regularly shaped or irregularly shaped. One particular type of filtering aid is formed from a diatomaceous earth material. For example, a filtration media may be supplemented with a diatomaceous earth material at ratios (by weight) of up to about 1:1 media to diatomaceous earth. In other embodiments, the ratio (by weight) of media to filtering aid may be as high as about 2:1 or higher or as low as about 1:2 or lower. In some embodiments, a very low pressure drop across the radial flow column can be achieved without sacrificing filtration performance or disrupting the flow kinetics through the column. Low pressure drops are advantageous, especially in pumped systems, since it is more energy efficient to operate a filtration column with a lower, rather than a higher pressure drop.

Diatomaceous earths, and in particular, biogenic diatomaceous earths, are used as filtering aid materials in some embodiments due to their relatively low density.

Advanced materials prepared via nanotechnology (for example, nanoparticulate metal oxides such as iron hydroxide, titanium dioxide, or alumina) show promising results in the removal of trace and ultra-trace level inorganic and organic contaminants from a contaminated fluid, such as water. However, these small size materials cannot be packed into standard columns since they would exhibit a high pressure drop with associated channeling. The exact nature of the pressure drop depends upon the type of materials packed into the column. For example, for small media with a high packing density, a higher pressure drop may be needed to obtain a desired filtration flow rate than for larger media with a lower packing density. The shape of the media may also be a factor in determining a pressure drop needed to achieve a desired filtration flow rate. For example, irregularly shaped media may be less easily packed into a high packing density media bed than regularly shaped media. Thus, a media bed containing irregularly shaped media may exhibit a lower pressure drop for a given filtration flow rate than a media bed containing regularly shaped media.

It has been found that blending small media particles (for example, with an average diameter of about 100 μm or less) with filtering aid materials such as diatomaceous earth at ratios (by weight) of, for example, 1:1 media to filtering aid material can provide a low pressure drop without compromising the kinetic performance of the filtration media. This enables the use of a wide range of media with different physical properties (for example, particle size and crystallinity) which can be blended with the diatomaceous earth to provide an overall media bed with a fairly low density, but which still retains the chemical properties of the media.

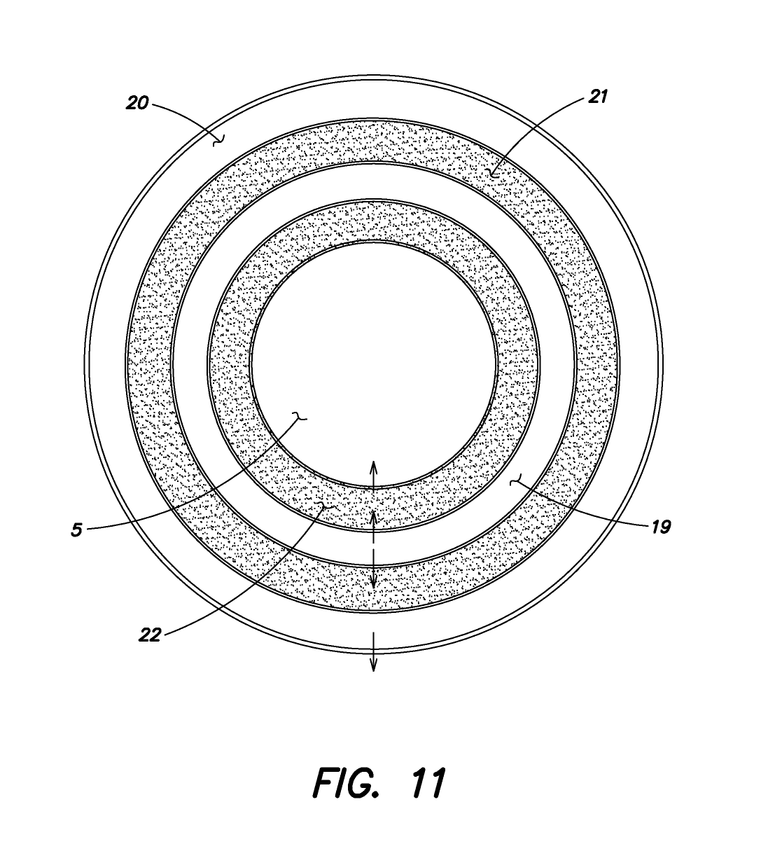

Testing on a lab scale radial flow column in accordance with an embodiment of the present disclosure has been carried out and the results are illustrated in FIG. 9. In this study, pressure drops corresponding to various filtration flow rates in a to filtration column using QSR, a small particle media having a particle diameter of 30 μm±10 μm, was compared with pressure drops corresponding to various filtration flow rates in an identical filtration column using a 1:1 mixture (by weight) of QSR and Celpure® diatomite filter media, a diatomaceous earth material.

FIG. 9 shows that the 1:1 mixture (by weight) of QSR and Celpure® diatomite filter media at a packing pressure of 15 psig proved to have a significantly lower pressure drop than QSR alone at the same packing pressure for a given filtration flow rate. Even dropping the QSR packing pressure to 2 psig, the 1:1 QSR:Celpure® diatomite filter media mixture in all cases gave a lower pressure drop.

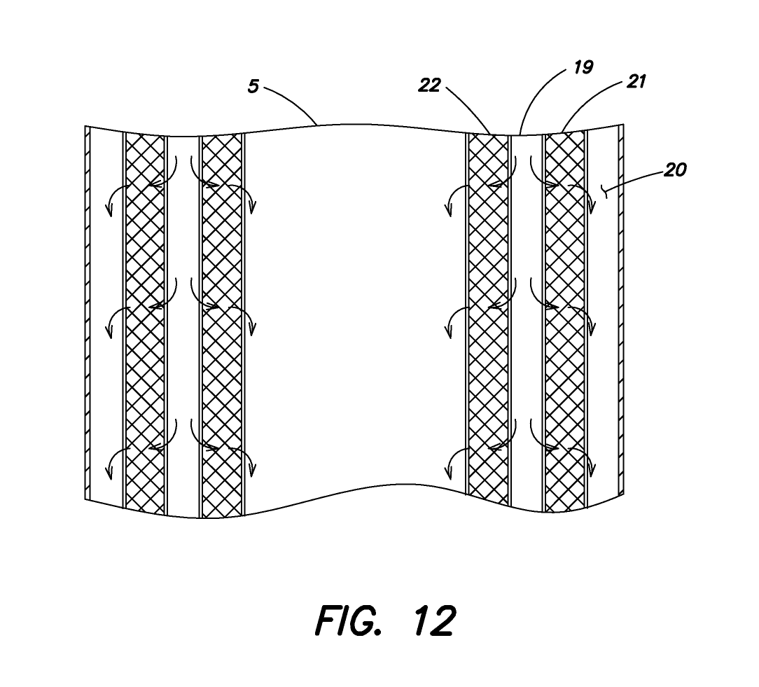

FIG. 10 shows that while the media blended with the filtering aid showed a reduced pressure drop, its efficacy at removing residual mercury from water was not compromised. QSR with Celpure® diatomite filter media at 15 psig showed rates of mercury removal that were comparable with QSR alone. The rate of mercury removal with QSR alone was fairly pressure independent.

Additional aspects and embodiments of the present disclosure comprise apparatus and methods of filtering waste water in a radial flow column in which the waste water flows from an inner pipe or lumen to an outer annulus by passing through the packed media. The media forms a porous matrix through which the contaminated water flows while the contaminants are extracted.

Further aspects and embodiments of the present disclosure include a method of determining dimensions of a radial flow column in which the waste water flows from an inner pipe or lumen to an outer annulus by passing through the packed media which exhibit high filtration performance. Filtration performance is related to the radial velocity of water flowing through the media bed. This flow velocity is dependent on the column dimensions. A rule of thumb rule which has been found useful in identifying criteria which can help improve column performance is that in designing a radial flow column it is desirable to achieve a low value for the dimensionless filtration performance coefficient IP (the ratio of average velocity through the media bed to the kinetic rate constant of the media in the media bed), defined as:

$$Ψ ∼ \frac{F / 2 π \overline{R} H}{k ( {R}_{2} - {R}_{1} )} = \frac{F / 2 π R H ( {R}_{2} - {R}_{1} ) / ln ( {R}_{2} / {R}_{1} )}{k ( {R}_{2} - {R}_{1} )}$$

$$Ψ ∼ \frac{ π ( {R}_{2}^{2} - {R}_{1}^{2} ) ln ( {R}_{2} / {R}_{1} ) H}{k ( {R}_{2} - {R}_{1} ) 2 π ( {R}_{2} - {R}_{1} ) H} = \frac{( {R}_{2} + {R}_{1} ) ln ( {R}_{2} / {R}_{1} )}{( {R}_{2} - {R}_{1} ) 2 k}$$

$$Ψ ∼ \frac{ln ( {R}_{2} / {R}_{1} )}{2 k} [ 1 + \frac{2 {R}_{1}}{( {R}_{2} - {R}_{1} )} ]$$

Where

F=Total flow rate

k=Kinetic (adsorption) rate constant

R₁=Radius of location of inner surface of media bed (cm)

R₂=Radius of location of outer surface of media bed (cm)

The above equations suggest that for a constant empty bed contact time (EBCT, the total bed volume divided by the flow rate), the filtration performance is not in any way affected by column height. However, for enhanced filtration performance, R₂, the outer radius, divided by R₁, the inner radius, should be less than about three.

For example:

For a column with R₁ of 10 cm and R₂ of 20 cm, the dimensionless performance coefficient Ψ is 1.04/k.

For a column with the same 10 cm bed thickness, but where R₁ of 2 cm and R₂ of 12 cm, the dimensionless performance constant Ψ is 1.25/k. Thus, it can be seen that the performance of the first column is about 20% greater than the second column, even though the bed thickness is the same.

The above equation suggests a thinner media bed would perform better than a thicker media bed. There are practical considerations regarding how thin a media bed to may be desired. For example, as a media bed becomes thinner, the flow rate of waste water to be treated through the media bed would desirably decrease to obtain a desired contact time of the water being treated with the media so that a desired amount of contaminants are removed. To maintain a given filtration flow rate, a column height of the filtration column would increase as the media bed thickness decreased. In some embodiments, a desired balance between column height and media bed thickness may be obtained when the ratio R₂/R₁ is between about 2 and about 3, corresponding to a Ψ of between about 1.04/k and about 1.1/k.

In existing radial flow columns, the pressure drop across the media bed is generally controlled by the media bed thickness. The thicker the media bed, the higher the pressure drop, and vice versa. When micro- or nano-sized media are used (for example, media with an average particle diameter in a range of from about 30 μm to about 250 μm), this issue becomes even more important, because the overall permeability of such media is inherently low. In practical terms, this means that only a fairly small bed thickness can be used with micro- or nano-sized media. Thus, to get a high specific filtration capacity using a radial flow column with micro- or nano-sized media, a very tall unit may be required

It has been discovered that by using one or more additional concentric annular media beds, a more compact form factor can be achieved for a given filtration capacity.

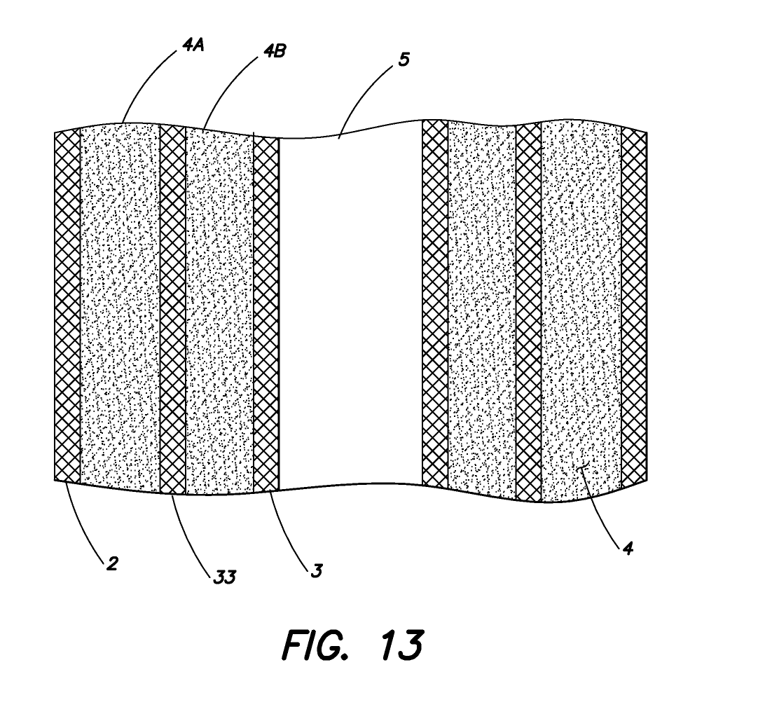

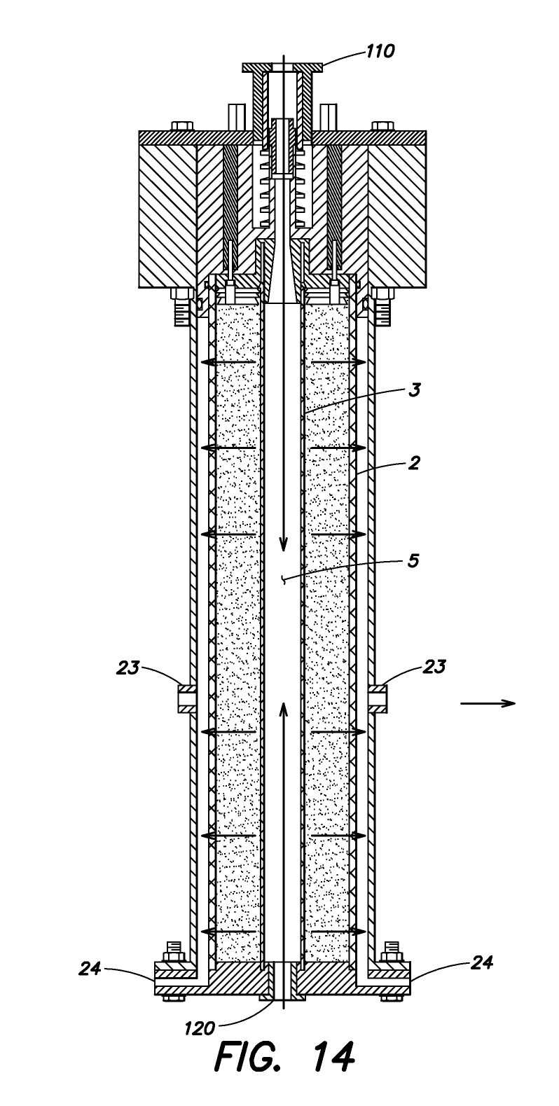

FIG. 11 and FIG. 12 show a device in which three fluid passageways are available for water flow, namely a lumen 5, a mid annular channel 19, and an outer annular channel 20. The device includes two concentric media beds, contained by screens or frits. An inner media bed 22 is located between the lumen 5 and the mid annular channel 19. An outer media 21 bed is located between the mid annular channel 19 and the outer annular channel 20. Inlet water enters the device and passes initially into the mid annular channel 19. The water then splits and passes into both the inner media bed 22 and outer media bed 21. The treated water then passes into the outer channel 20 and the lumen 5. In some embodiments, the thicknesses of the inner media bed 22 and outer media bed 21 are balanced such that in operation water passing through the inner media bed 22 is treated substantially equally to water passing through the outer media bed 22. For example, the thicknesses of the inner media bed 22 and the outer media bed 21 may be determined to provide for fluid flow rates through each of the inner and outer media beds that would yield equivalent contact time of the water flowing through each with the media contained therein. Additionally or alternatively, a packing density or a filtration aid to media ratio in the media beds 21, 22, may be selected to yield equivalent contact time of the water flowing through each with the media contained therein.

Each media bed 21, 22 exhibits its own pressure drop. Such a configuration can provide a similar filtration capacity in a shorter unit that would be provided in a taller unit having a single media bed. For example, a computational fluid dynamics (CFD) analysis shows that an annular media bed with a thickness of 200 mm and a height of 380 mm operated at a wastewater treatment rate of 80 liters per minute (1 bed volume per minute) exhibits a pressure drop of 147 psi for a given micro media. Decreasing the bed thickness to 100 mm, while maintaining the same wastewater treatment rate would give a concomitant decrease in pressure to 34 psi, but the height would need to increase nearly threefold, from 380 mm to 1100 mm, to achieve the same bed volume and therefore the same filtration capacity.

Using a split flow configuration, with for example, two concentric 100 mm thick beds, the height of the flow column can be maintained low, for example, 460 mm, while a pressure drop of 26 psi may be applied to achieve the same wastewater treatment rate as above.

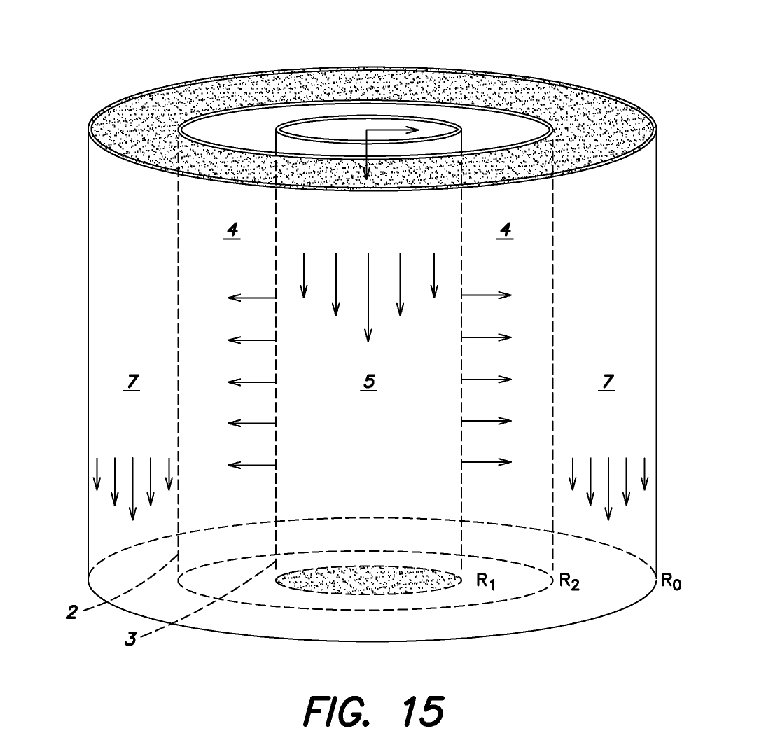

In another embodiment, a media bed for use in a radial flow column may include multiple layers, each with a different form of media contained therein. Such layered media beds provide for the use of different types of media, for example, sorbent media designed for the removal of different types of metals, in the same media bed. An example of an axially layered media bed is illustrated in FIG. 13, a cross section of an annular media bed which may be used with any of the embodiments of radial flow columns described herein. The axially layered media bed of FIG. 13 includes, in addition to the inner media screen 3 and the outer media screen 2, an intermediate media screen 33 in the media bed 4, which is substantially parallel to the screens 2 and 3. The intermediate media screen 33 divides the media bed 4 into two section, section 4A and section 4B.

The two sections 4A and 4B may be filled with different types of media. For example, one of sections 4A, 4B may be filled with activated charcoal while the other of sections 4A, 4B is filled with an ion-exchange resin. In another embodiment, one of the sections 4A, 4B may be filled with a media specially adapted for removal of a first contaminant, for example, mercury from contaminated water, while the other of the sections 4A, 4B is filled with a media specially adapted for removal of a second contaminant, for example, copper from contaminated water. This embodiment would prove beneficial in situations where there are two media with excellent performance with regard to specific contaminants and the water to be treated includes both of the contaminants.

In a further embodiment, media in both of sections 4A and 4B may be used for removing the same contaminant, for example mercury, from a fluid stream, for example, mercury contaminated water. The first media that the fluid being treated passes through (for example, media in the bed section 4B when the radial flow column is operated in inside-out filtration mode) can be a relatively inexpensive media used to bring the contaminant concentration down from, for example, a parts-per-million (ppm) level to a parts-per-billion (ppb) level. The second media that the fluid being treated passes through (for example, media in the bed section 4A when the radial flow column is operated in inside-out filtration mode) can be more expensive media specially adapted to reduce the contaminant level of the fluid being treated from, for example, a ppb level to a parts-per-trillion (ppt) level. This combination would reduce the amount of the more expensive media used, and thus the overall cost of the media in the media bed.

The two sections 4A, 4B in some embodiments have substantially equal or equal volumes, and in other embodiments have different volumes. The volumes of the sections 4A, 4B may be selected depending on the types of media to be used and the types of contaminants and desired level of contaminant removal desired. For example, if a radial flow column using a layered media bed such as illustrated in FIG. 13 were to be used for the removal of both mercury and arsenic from wastewater using mercury removal resin and arsenic removal resin, and the wastewater contained more mercury than arsenic, or if the mercury removing resin utilized operated with slower kinetics than the arsenic removal resin, it could be desirable to size the section of the bed holding the mercury removing resin greater than the section of the bed holding the arsenic removal resin. In addition, the pore or mesh sizes of each screens 2, 3, and 33 need not be equal, but could be selected based on the particle size of media to be enclosed in the compartments defined by these screens.

In different embodiments, a media bed could be divided into more than two layers. For example additional intermediate screens could be added to the media bed of FIG. 13 to provide a layered media bed with 3, 4, or more layered sections.

In some embodiments, the different layers of media may be provided without an intermediate media screen dividing them. The different layers of media may have an abrupt interface between them or, in other embodiments, may have an interface between media layers that exhibits intermixing. In some embodiments, a composition of a media bed may vary smoothly from one side of the bed to the other with one side of the media bed having media primarily of a first composition, and another side of the media bed having media primarily of a different composition. In further embodiments, multiple types of media may be mixed together at a substantially constant mixing ratio throughout the media bed.

Media beds in accordance with some embodiments may additionally or alternatively be layered horizontally, with the composition of the media bed varying along a length of the flow column. The horizontal layers may exhibit abrupt interfaces from one layer to another, or interfaces with mixing of media types, and may or may not include media screens dividing the horizontal layers. In some embodiments, a thickness of the media bed may be adjusted to account for the different permeabilities of the different media in the different layers. For example, if a first layer of media had a significantly lower permeability than a second, water to be treated might preferentially flow through the second layer of media rather than the first. To induce an equal, or approximately equal amount of water to pass through both the first and second layers, the layer with the greater permeability could be provided with a greater thickness than the layer with the lower permeability. The bed thickness along a radial flow column may also be varied to account for pressure differentials due to, for example, gravity, to accomplish substantially equal flow through the media bed along the length of the column.

Further, a pressure exerting element, such as the bladder 9, or the scrubber 14 described above could be provided for each section of a layered media bed. Each section of the media bed could individually be pressurized to a packing pressure or packing density appropriate to the type of media in the section.

A further benefit arising from the use of radial flow columns with media beds maintained at a constant packing density is that they can be used in any orientation. Conventional axial flow filtration columns must be operated in a vertical configuration, however, the columns of the present disclosure can be operated vertically, (i.e., with the lumens vertical), horizontally, or at any angle in between without any anomalous effects on the flow distribution. In some embodiments, when operated non-vertically, a radial flow column may be provided with a bladder 9 or piston 13 and scrubber 14 at one or both ends of the media bed of the radial flow column.

The use of pressure to move the fluid through the media bed means that the effect of gravity on the flow pattern is negligible. The present inventors have modeled the pressure distribution and found that even in a vertical flow column, the axial pressure distribution, away from the lumens, is equal in all directions.

The use of pressure to move the fluid through the media bed also provides for radial flow columns with greater versatility to be scaled-up for commercial use. For example, one approach to scale up capacity is to provide a number of filtration columns in parallel. The orientation of the filtration columns plays a role in the assembly configuration. The versatility of the radial flow columns of embodiments of the present disclosure to be arranged in a horizontal orientation enables a horizontal stacked configuration rather than several vertical cylinder type configurations which would require a larger footprint.

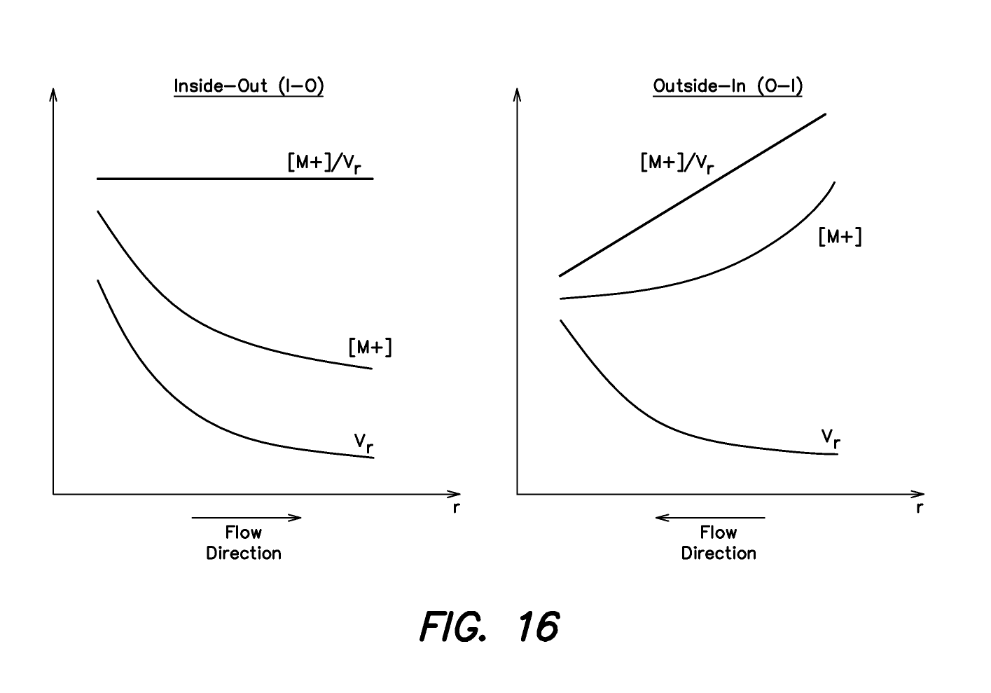

Another embodiment of the disclosure is shown in FIG. 14. Where use of a relatively tall column is unavoidable, there is the possibility that a problematic pressure gradient can arise in the inlet channel of the lumen. This pressure gradient could result in different flow velocities of liquid being treated through different portions of the media bed, which could result in uneven usage of the media, and exhaustion of media in one section of the media bed before exhaustion of media in another portion of the media bed. This problem can be addressed by splitting the inlet flow into two, from the top and the bottom of the column. This flow is also beneficial when it is desired to increase column capacity while maintaining a constant bed thickness along the length of the column. It is generally desired that flow rates into both the top 110 and the bottom 120 inlets are equal, or at least substantially equal, to avoid short-circuiting, leading, for example, to the situation where one of the flows has less residence time in the column than the other, giving quality variation of the treated water. As shown in FIG. 14, the flow column has an upper inlet 110 and a lower inlet 120, both inlets in fluid communication with the lumen 5 of the flow column. One or more filtrate outlet channels 23 are located in the middle of the column. One or more additional filtrate outlets 24 may be located at another position, for example, proximate the bottom of the column.

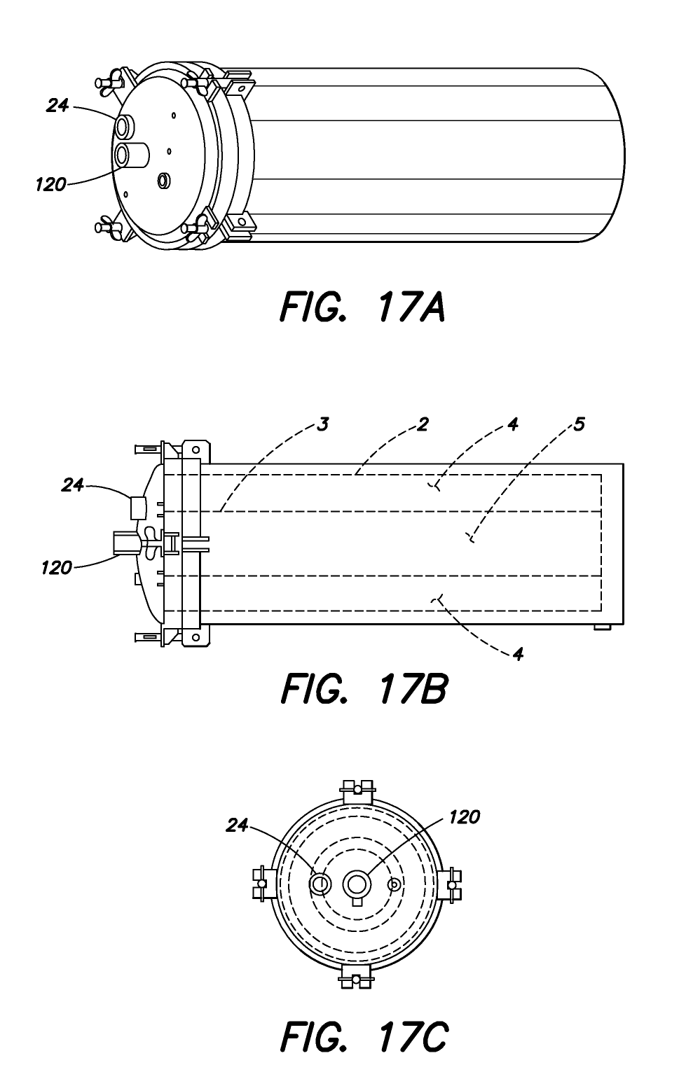

Yet a further embodiment of the disclosure is disclosed with reference to FIG. 15. Conventional commercially available radial flow columns first run the contaminant fluid (for example, water contaminated with heavy metal) into the outer annulus 7, that is, the space between the outer screen and the wall of the fluid chamber. The contaminant stream is then passed radially inwardly through the media bed 4, where the contaminants are removed. The treated fluid is then drawn off via the central lumen 5. This is referred to as centripetal (CP) or outside-in (O-I) flow.

It has been discovered that superior performance can be obtained by passing the fluid through the column in a manner counter to the usual direction, that is, in some aspects and embodiments of the present disclosure the contaminant stream may be initially fed into the lumen space 5 defined by the inner screen 3 then passed radially outwardly through the media bed 4. The decontaminated stream then exits into the outer annulus 7, from where it is drawn off, as indicated in FIG. 15. The flow method of this particular aspect of the present disclosure can be referred to as inside-out (I-O) or centrifugal (CF) flow.

Conventional O-I flow can result in uneven extraction of contaminants, where high extraction rates primarily occur near the outer annular perimeter of the media bed 4, and lower levels of extraction take place nearer the lumen 5. Because the media bed 4 is largely immobile, high levels of contaminants are taken up (for example, by adsorption) at the outer annular perimeter, while much smaller amount of contaminants are taken up in the media bed proximate the inner annular perimeter. This results in a maldistribution of bed utilization. However, the I-O flow of embodiments of the present disclosure allows for more uniform utilization of the filtration media, minimizing maldistribution of media bed utilization, and allowing apparatus performance to be maintained for a longer period. Also, because the filtration media is used evenly, when the time comes to replace the media, there is no need to attempt to recover that portion of the filtration media with residual capacity.

This can enhance the ease of operation and maintenance of the apparatus while minimizing the recurring operational cost.

The advantages of an I-O flow configuration for a radial flow filtration column over an O-I flow configuration for a radial flow filtration column can be explained as follows:

Regardless of which direction the fluid flows, it moves at different velocities (Vᵣ) at different points in the media bed due to the differences in the available surface area of the media and the reduced cross sectional area of the media bed closer to the lumen. Relatively higher radial fluid flow velocities (Vᵣ) are exhibited in the inner region (near the lumen 5) whereas relatively low Vᵣs are exhibited in the outer annular regions.

In O-I flows, the contaminant concentration [M⁺] is higher in the outer region than in the inner region, providing better kinetics for absorption of the contaminant onto the filtration media in the outer region as compared to in the inner region. In contrast, in I-O flows, the opposite occurs, with better kinetics taking place in the inner region. This difference gives rise to a significant difference in the overall performance of contaminant extraction. A higher extraction rate is achieved when [M⁺] is higher (high kinetics rate), or V, is lower (where there is a longer contact time between contaminant and media), or both. For example, a higher contaminant extraction rate would be observed at points in a flow column where the ratio [M⁺]/Vᵣ is higher than at points in a flow column where the ratio [M⁺]/Vᵣ is lower.

In O-I flows, the initial conditions at the outer perimeter of the annulus are that [M+] is high and V, is low, resulting a higher contaminant extraction rate relative to the central region, where [M+] is lower, and V, is higher.

In I-O flows, the initial conditions at the inner perimeter of the annulus are that [M+] is high and V, is high, resulting in a moderate contaminant extraction rate.

In the outer region, [M+] is low, and V, is low, also resulting in a moderate contaminant extraction rate. In filtration columns operated using I-O flows, the parameters of [M+] and V, are better balanced across the width of the media bed than in similar filtration columns operated using O-I flow.

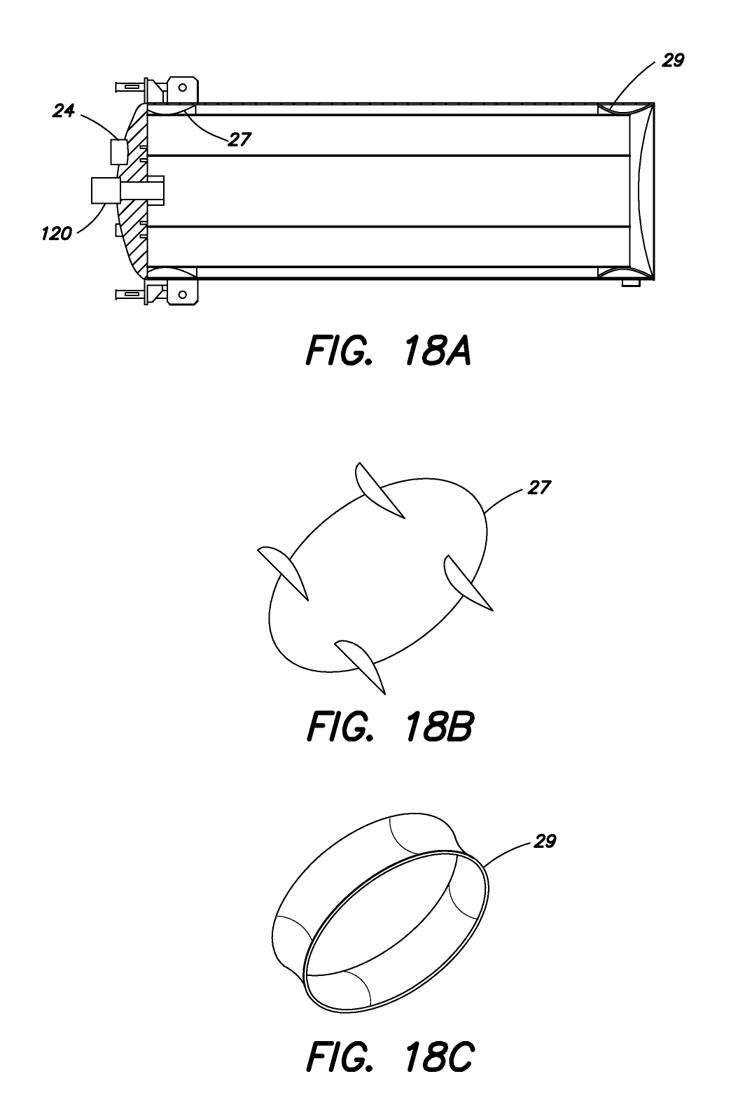

FIG. 16 shows the maldistribution of [M+] and V, for O-I flow type radial flow filtration columns, which can lead to non-uniform media bed utilization. FIG. 16 also illustrates that in I-O flow type radial flow filtration columns, in accordance with embodiments of the present disclosure, the media bed is utilized much more uniformly than in O-I flow type filtration columns Notably, in the I-O flow type filtration columns, the [M⁺]/Vᵣ ratio may be substantially uniform throughout the media bed, suggesting that when the filtration media is exhausted, it will be uniformly so and can be replaced all at one time. In O-I flow type filtration columns, after operation for a given period of time some of the filtration media (for example, media proximate the outer periphery of the media bed) may be well past exhaustion, while other filtration media (for example, the media proximate the outer periphery of the media bed) remains in good condition. Thus, the options are to continue to run the column with much of the filtration media ineffectual, to discard the filtration media even though a large portion remains potentially useful, or to separate the filtration media. These options are less desirable and more costly than using the media more efficiently in the first instance, as may be accomplished with embodiments of the present disclosure utilizing I-O flow type filtration columns.

In one embodiment, the media bed is packed at a predetermined packing density of from about 1 psig to about 3 psig with a filtration media comprising a sorbent and a filtration aid. The inner and outer dimensions of the column are selected so as to achieve a desirably low value of the dimensionless value Ψ as described above. An adjustable element maintains the predetermined packing density within the media bed. The fluid flow in the apparatus is from the inner lumen of the bed to the outer wall, i.e. fluid flow is from across the media bed is from R₁ to R₂.

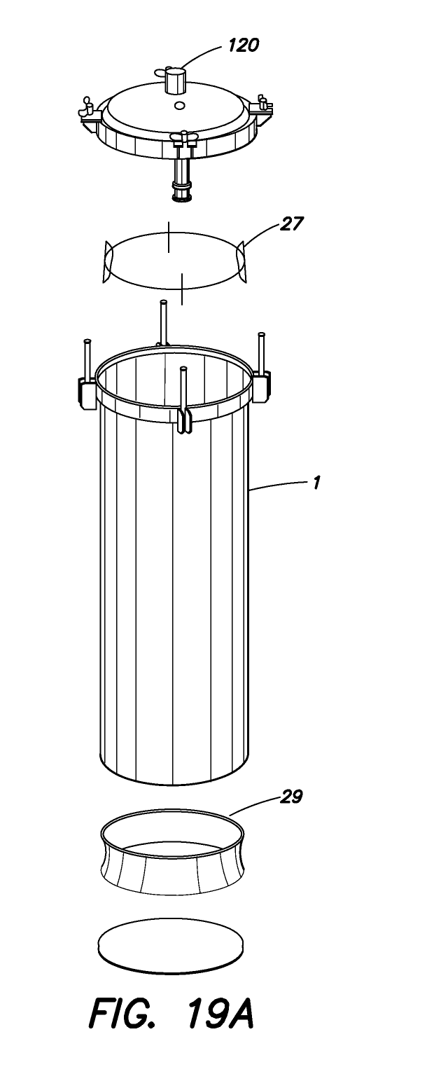

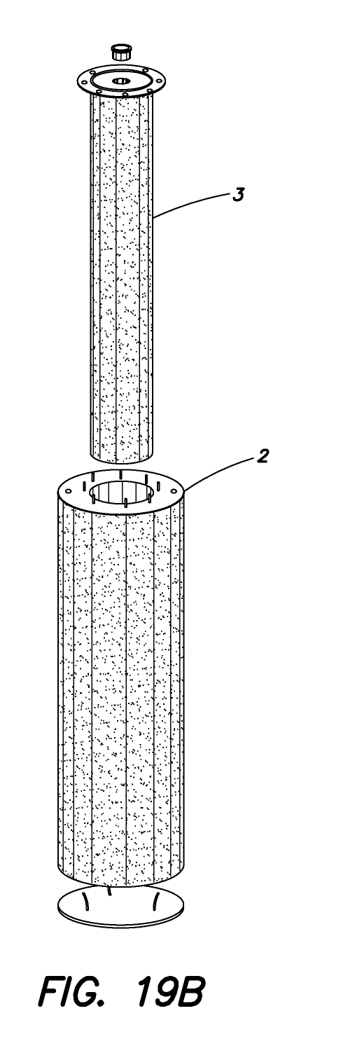

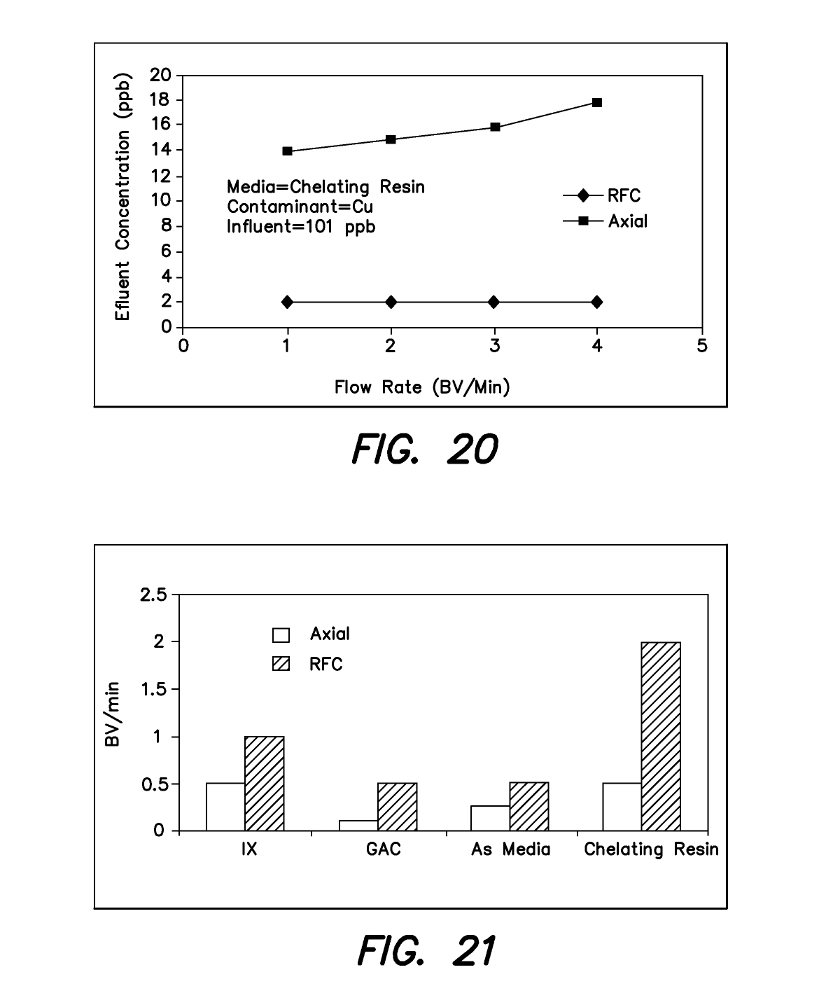

FIG. 17A, FIG. 17B, and FIG. 17C illustrate an embodiment of a device of the present disclosure, with the location of the annular media bed 4 shown in broken lines and with an waste water inlet 120 and an filtrate outlet 24 located on a same side of the device. FIG. 18A, FIG. 18B, and FIG. 18C show further details of the device, including a head cartridge aligner 27 and a bottom cartridge aligner 29 used to maintain the annular media bed 4 in a central location within the column FIG. 19A and FIG. 19B show an exploded view of the device, with FIG. 19A showing the outer assembly and FIG. 19B showing the media bed and screens. Details such as the inflatable bladder are not shown in FIGS. 17-19.

### Example 1

Performance of a radial flow column constructed and operated in accordance with an embodiment of the present disclosure (referred to herein as the “RFC” column) was compared with that of an axial flow column.

The RFC column was 70 mm high with a diameter of 110 mm and a single annular media bed with a height of 40 mm, an inner diameter of 20 mm, and an outer diameter of 60 mm. The RFC column was operated in inside-out filtration flow mode. The various media used in the RFC column in the tests described below had an average diameter of about 90 μm±10 μm, with media particle diameters ranging from about 90 μm to about 250 μm.

The axial flow column had a media bed with a height of 330 mm and a diameter of 12.5 mm. The various media used in the axial flow column in the tests described below had particle diameters of between about 0.5 mm to about 1.0 mm

### Copper Removal Performance:

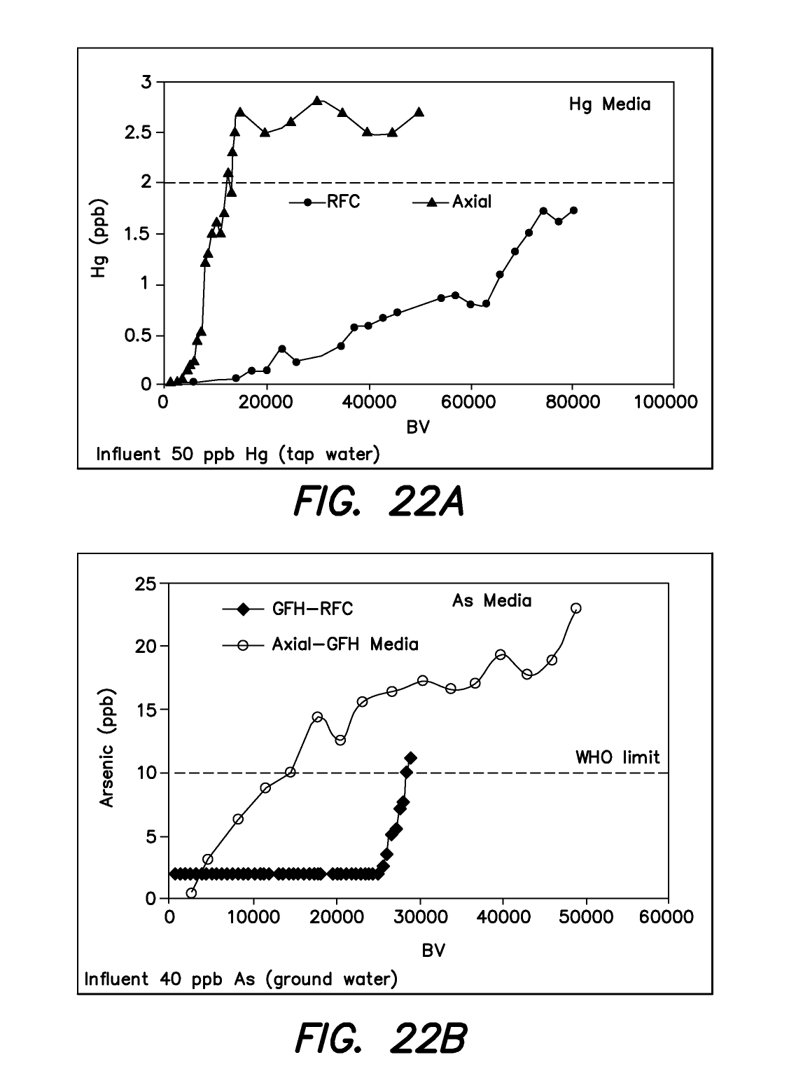

Both the RFC column and the axial flow column were filled with a same chelating resin. The chelating resin was packed in the RFC column at a pressure of about 25 psig. An influent comprising water contaminated with 101 ppb of copper was introduced into both columns at various flow rates (measured in bed volumes/minute (BV/min)), and the amount of copper remaining in the effluent from the columns was measured using ICP-OES (inductivity coupled plasma-optical emission spectrometry). The results of this test are illustrated in FIG. 20. As can be seen, the RFC column removed copper from the influent to a level of about 2 ppb in the effluent for flow rates ranging from 1 to 4 bed volumes/minute. In contrast, the axial flow column removed copper down to only about 14 ppb in the effluent at a flow rate of 1 bed volume/minute, with the removal performance decreasing with increased flow rate.

This test indicates that the RFC column performed better with regard to removing copper from a contaminated water stream than the axial flow column, and that the RFC column could be operated at a higher flow rate than the axial flow column without the copper removal performance decreasing significantly.

### Flow Rate Comparison:

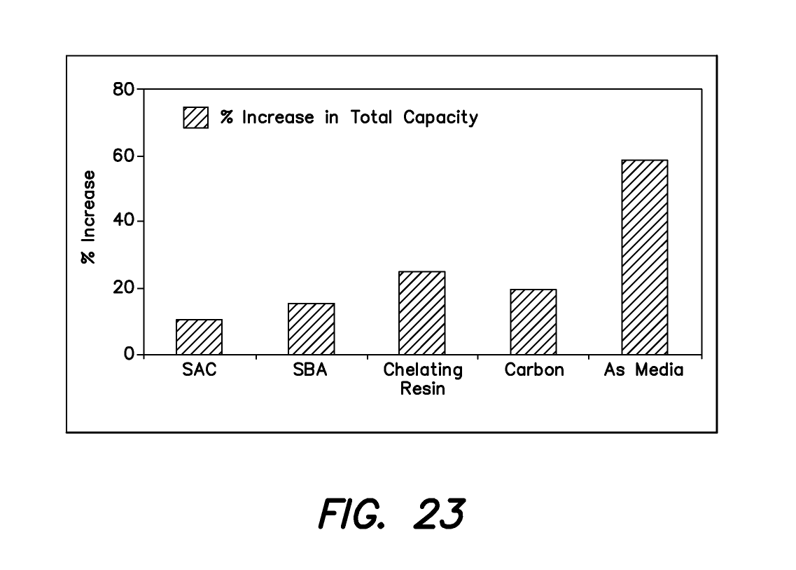

Both the RFC column and the axial flow column were operated with a water influent pressure of about 1 psig to about 2 psig. The two columns were each filled with different filtration medias, including an IX media (a media including both cation and anion exchange resins), granular activated carbon (GAC), an arsenic adsorbing media, and a chelating resin. Each of the medias was packed in each of the columns with a packing pressure of zero psig. The flow rate of water through the two columns at a pressure of between about 1 psig and about 2 psig was then compared. The results are shown in FIG. 21. As can be seen, the RFC column exhibited higher flow rates for each of the medias than the axial flow column. For example, the RFC column exhibited a flow rate of about 1 bed volume/minute using the IX media, while the axial flow column exhibited a flow rate of 0.5 bed volumes/minute using the IX media.

These results indicate that the RFC column could be operated at a higher throughput for a given influent pressure than the axial flow column, and therefore could be operated more energy efficiently than the axial flow column.

### Long Term Performance:

The long term performance for mercury and arsenic removal for the RFC column was compared with that for the axial flow column.

For the mercury removal test, influent water contaminated with 50 ppb mercury was supplied to both columns, which were filled with the same mercury removal media. The media was packed in the RFC column at a pressure of about 25 psig. The axial flow column was operated at a flow volume of 0.5 bed volumes/minute, while the RFC column was operated at 2 bed volumes/minute. The two columns were operated at different rates to illustrate that the RFC column could operate as well or better than the axial flow column even at a higher filtration rate.

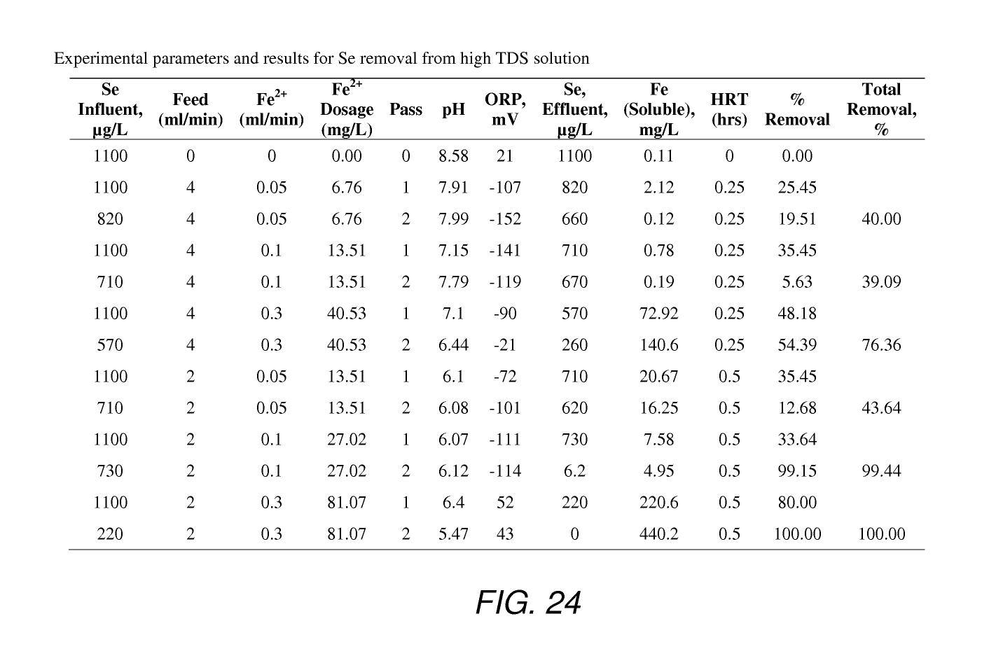

Mercury levels in the effluent of each column were measured using ICP-OES and plotted against cumulative filtration volume. The results of this test are illustrated in FIG. 22A. As can be seen, the residual mercury in the effluent increased with filtered water volume for both columns. The increase in residual mercury in the column effluent with increasing filtered volume was more gradual for the RFC column than for the axial flow column. The RFC column exhibited less than 2 ppb mercury in the effluent stream even after filtering 80,000 bed volumes of water. In contrast, a level of 2 ppb mercury in the effluent of the axial flow column was reached after significantly less than 20,000 bed volumes of water had been filtered.

For the arsenic removal test, influent water contaminated with 40 ppb arsenic was supplied to both columns, which were filled with the same arsenic removal media. The media was packed in the RFC column at a pressure of about 25 psig. The axial flow column was operated at a flow volume of 0.5 bed volumes/minute, while the RFC column was operated at 1 bed volume/minute. Arsenic levels in the effluent of each column were measured using ICP-OES and plotted against cumulative filtration volume. The results of this test are illustrated in FIG. 22B. As can be seen, the residual arsenic in the effluent increased with filtered water volume for both columns. The residual arsenic in the effluent from the RFC column remained substantially constant, at about 2 ppb, until after about 25,000 bed volumes had been filtered, at which point the residual arsenic levels increased, presumably due to exhaustion of the arsenic removal media. The RFC column exhibited less than 10 ppb arsenic (the World Health Organization limit for arsenic contamination in drinking water) in the effluent stream even after filtering about 25,000 bed volumes of water. In contrast, an arsenic level of 10 ppb in the effluent of the axial flow column was reached after less than about 15,000 bed volumes of water had been filtered.

The above results show that the RFC filtration column was capable of filtering contaminants such as mercury and arsenic from a greater quantity of water than the axial flow column before residual levels of these contaminants in the effluent stream increased to an undesirable level.

### Filtration Capacity Comparison:

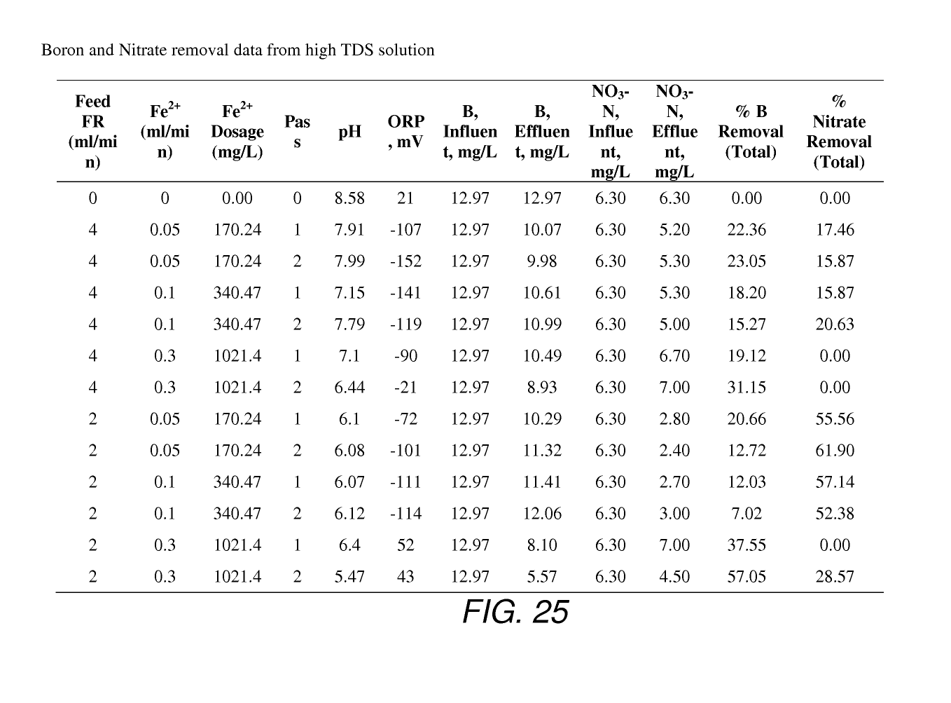

Testing was performed to determine the filtration capacity of the RFC column as compared to the axial flow column for various media types including SAC media (a strong acid cation exchange resin used to remove calcium from water in this test), SBA media (a strong base anion exchange resin used for removal of nitrate from water in this test), chelating resin (Lewatit® TP 207 weakly acidic, macroporous cation exchange resin, with chelating iminodiacetate groups, available from Lanxess Engineering Company, used to remove copper from water in this test), granular activated carbon (used to remove copper from water in this test), and As removal media. Both the RFC column and the axial flow column were run until breakthrough for each of the media types. After breakthrough, the media used was removed from the two columns and the contaminant concentration in the solid phase was measured. The contaminant concentration was measured by removing a known weight of dried media from the columns, acid digesting the media in accordance with EPA method 3050B, and analyzing the acid digested media for target ions using ICP-OES. The results are illustrated in FIG. 23, which shows that the RFC column has a filtration capacity of between about 10% (for the SAC media) and about 60% (for the AS media) greater than the axial flow column.

These results can be explained because the relatively smaller media used in the RFC column as compared to axial flow column (90 μm±10 μm diameter media for the RFC column and 0.5 mm to about 1.0 mm diameter media for the axial flow column) had a greater surface area, and thus a greater capacity for adsorbing contaminants. The RFC column was able to operate with smaller media then the axial flow column due to the lower pressure drop exhibited in the RFC column as compared to the axial flow column and the corresponding reduction in potential for channeling.

### Example 2

Testing was carried out to evaluate the performance of an embodiment of a radial flow column as disclosed herein for the removal of selenium (Se) from influent water contaminated with various levels of selenium over various time periods.

### Materials and Methods:

A radial flow column was provided with magnetite coated zero-valent iron (ZVI) as a contaminant-removing media. For initial screening tests, iron powder having a particle size of less than 212 μm (about 75 mesh, available from Sigma Aldrich) was used. A stainless steel screen with an aperture size of about 90 μm was used to sieve 250 g of the ZVI powder, yielding about 140 g of ZVI powder with a particle size of less than 90 μm. This media was used for studies of selenium removal from low TDS (less than 0.1 g/L) and high TDS (about 22 g/L) solutions.

For long-term feasibility studies, ZVI H200 Plus (available from HePure) with a particle size of less than 45 μm (about 325 mesh) was used.

The ZVI media used in the testing described in this example was coated with magnetite to form “activated ZVI” in accordance with the following procedure:

A 30 mg/L solution of NO₃—N was prepared by adding 0.182 g of NaNO₃ to 1 L of de-ionized (DI) water in a glass bottle. The solution pH was adjusted to about 2.3-2.4 by adding approximately 0.52-0.54 mL of 37% HCl solution. The solution was deoxygenated by purging with nitrogen gas for 20-30 minutes. The solution was augmented with 50 g of ZVI powder and the bottle was sealed and shaken on a bench top shaker overnight (about 16 hrs). The activated ZVI was filtered under reduced pressure and washed with deoxygenated DI water several times until the filtrate was colorless. The activated ZVI media was then dried under a stream of nitrogen for 3-4 hours before use.

A radial flow column (a “column”) having a single media bed enclosed within 20 μm fitted screens and having a media bed volume of 62.3 mL was used for the testing described in this example. The column was purged with nitrogen gas for 30 minutes before loading the media to remove traces of oxygen. For the screening tests, the activated ZVI media with a particle size of less than 90 μm was suspended in deoxygenated DI water and the slurry was loaded into the column through media inlet ports while applying vacuum at an effluent outlet port to prepare tight packing of the media. After the packing, the media inlet ports were sealed tightly and the column was thoroughly purged with nitrogen from the influent port through the effluent port for 1 hour. The column was kept sealed until further use.

About 110 g of ZVI media with a particle size of less than 90 μm was used for packing the column for the screening tests while about 140 g of ZVI media with a particle size of less than 45 μm was used for packing the column for long-term tests.

An inline pressure gauge was mounted before the fluid inlet of the column to monitor the pressure differential across the column. Sodium selenate (Na₂SeO₄) was used as the source of selenium.

Concentrations of selenium used in solutions in the tests were in the range of between 800 ppb and 1,400 ppb.

Low TDS solutions were prepared by dissolving Na₂SeO₄ in DI water, while high TDS solutions was prepared by dissolving Na₂SeO₄ in a solution having the following components:

TABLE 1
Make-up of high TDS solution as synthetic waste (measured values).

| | | |
|---|---|---|
| pH | 8.20 | SU |
| Alkalinity | 770.00 | mg/L CaCO3 |
| TDS | 22100.00 | mg/L |
| Chloride | 10950.00 | mg/L |
| Nitrate | 16.90 | mg/L N |
| Sulfate | 1360.00 | mg/L |
| Boron | 281.50 | mg/L |
| Calcium | 2950.00 | mg/L |
| Magnesium | 1710.00 | mg/L |
| Manganese | 5.55 | mg/L |
| Selenium | 1.40 | mg/L |
| Silicon | — | mg/L |
| Sodium | 948.40 | mg/L |
| Strontium | 16.31 | mg/L |

Iron(II) Chloride Tetrahydrate (FeCl₂.4H2O) was used as the source of Fe²⁺ ions. A 10 mM stock solution of Fe²⁺ was prepared by adding 1.9881 g of FeCl₂.4H₂O to 1 L of deoxygenated 5 mM HCl solution.

### Results and Discussion:

### Screening Tests:

Initial screening tests were carried out to evaluate the feasibility of using the packed column for selenium removal from low TDS water. The experimental parameters and results are listed in the Table 2 below.

TABLE 2
Experimental parameters and results for selenium removal from low TDS solution

| Se(VI) | | | Fe²⁺ | | | Se | Fe | | |
|---|---|---|---|---|---|---|---|---|---|
| Influent | Feed | Fe²⁺ | dosage | | ORP | effluent | (Soluble) | HRT | % Se |
| (μg/L) | (mL/min) | (mL/min) | (mg/L) | pH | (mV) | (μg/L) | (mg/L) | (hours) | Removal |
| 980 | 2 | 0.13 | 35.13 | 5.05 | 2 | 34 | 302.9 | 0.5 | 96.53 |
| 980 | 1 | 0.16 | 86.47 | 3.46 | 164 | 20 | 330.9 | 1 | 97.96 |
| 980 | 0.5 | 0.16 | 172.94 | 3.81 | 137 | 10 | 308.1 | 2 | 98.98 |
| 2200 | 4 | 0.23 | 31.08 | 6.42 | −144 | 0 | 83.29 | 0.25 | 100 |
| 2200 | 2 | 0.23 | 62.15 | 6.49 | −148 | 0 | 186.7 | 0.5 | 100 |

Magnetite coated ZVI media having a particle size of less than 90 μm was used in the screening tests. Initial experiments were carried out with a selenium feed concentration of 980 ppb and an iron dosage of 35 mg/L. The samples were collected after two hours of operation to equilibrate the system. The variation in iron dosage was due to the variation in the pump that was used during these tests. Different hydraulic retention times (HRTs) were evaluated at different iron dosages. Effluent selenium concentrations of less than 5 ppb (the lower detection limit of the inductively coupled plasma spectrometer utilized to perform the concentration measurements) are reported as 0. Undetectable selenium concentrations were found in the effluent at all HRTs in tests where the influent included 2,200 ppb of selenium while removal rates of 96% to 98% were observed in tests where the influent included 980 ppb of selenium.

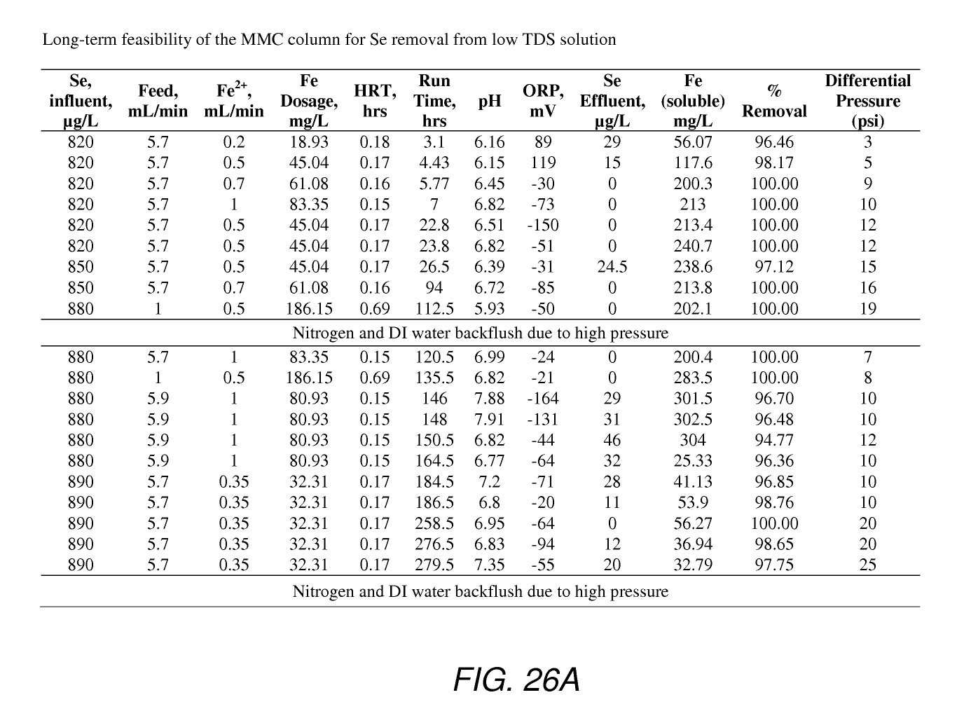

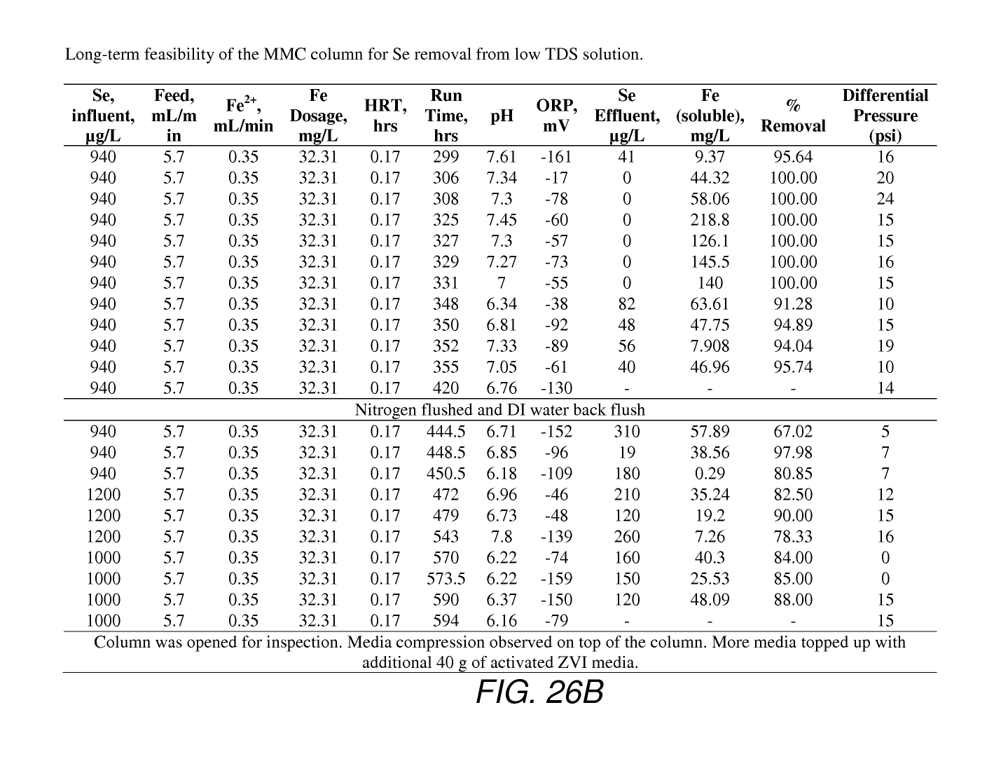

The selenium removal data for the high TDS solution is shown in the table of FIG. 24. Activated ZVI media having particle size less than 90 μm was used for high TDS solution tests. Two different HRTs were evaluated with varying iron dosages. The selenium removal % appeared to be a function of iron dosage. At a HRT of 15 min, an iron dosage of 40 mg/L resulted in 76% removal of Se. At a HRT of 0.5 hours, about 99% removal of selenium was observed using an iron dosage of 27 mg/L. Due to the low amount of removal of selenium in a single pass through the column, the effluent from the first pass was eluted through the same column in a second pass under the same condition as the first pass. Some degree of boron and nitrate removal was observed under some of these conditions. The boron and nitrate removal data is shown in the table of FIG. 25.

### Long-Term Tests:

Long term feasibility tests were carried out for a period of two months (about 30 days total run time). Magnetite coated ZVI media having a particle size of less than 45 μm was used in these studies. Since it was established that the larger particle size ZVI was capable of selenium removal at 15 min HRT, smaller ZVI particles were used in these studies to examine even shorter HRTs as well as to compare the performance of the column where similar ZVI is used. All experiments, barring a few, were carried out at HRT of between 10.2 and 12 minutes.

The column was operated substantially continuously with intermittent discontinuation due to several reasons such as hardware (tubing, pump etc.) malfunctions, excessive pressure (>25 psi) differential across the column being observed, feed and iron solution preparation, and observed decreases in selenium removal efficiency.

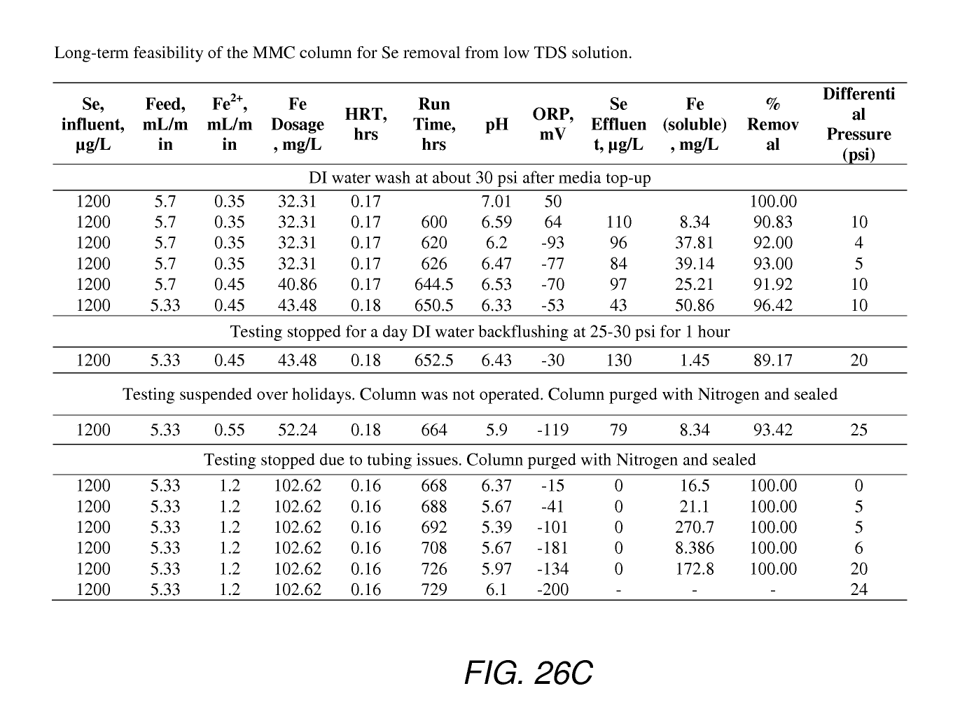

The testing was carried out for one week during which the selenium concentration was reduced from about 900 ppb to a range of between 100 ppb and 150 ppb. Several iron dosages (30-150 mg/L) were attempted to improve the selenium removal efficiency. However, the selenium in the effluent remained in the range of 100 ppb to 150 ppb. The column was opened and incomplete packing of the media in the column was observed. It was theorized that the incomplete packing of the media could have resulted in channeling and therefore, incomplete selenium removal. Testing was resumed after re-packing of the column with fresh media. Iron dosages were varied in order to identify the best operating conditions. The data over a total run time of 30 minutes is summarized in the tables of FIGS. 26A, 26B, and 26C.

The effluent selenium concentration in the effluent from the column initially remained between 0 ppb and 50 ppb for approximately 400 hours. The selenium concentration in the effluent from the column then increased to greater than 200 ppb. At this point the column was opened for inspection and media compression in the column was observed, which could have contributed to channeling and therefore loss of process efficiency. The column was filled with additional freshly activated ZVI media. Hardening of the media was not observed and upon close observation, no brown coloration of the media was noticed, which indicated that the ZVI was not oxidized to higher inactive oxides. After the column replenishment, the usual iron dosage of 30 mg/L did not yield the expected selenium removal efficiency of greater than 99%. Therefore, the iron dosage was gradually increased from 30 mg/L to 100 mg/L. Selenium removal of up to 100% was achieved at iron dosages of 100 mg/L.

The column was periodically backflushed with deoxygenated DI water and nitrogen or whenever the pressure approached 20 psi.

### CONCLUSIONS

The radial flow column operated with ZVI media was effective at removing selenium from selenium contaminated solutions.

Up to 100% removal of selenium was observed with ZVI media having a particle size of less than about 90 μm from low TDS and high TDS solutions at HRT of 0.25 hrs and 0.5 hrs per pass in a two-pass process.

High selenium removal efficiency of greater than 95% was consistently achieved for about 400 hours of continuous run time at HRTs of 10-11 minutes. The radial flow column configuration offers significant improvement over standard fluidized bed reactors in terms of operational cost by providing for operation with a reduced HRT, with reduced media carry over, providing for the elimination of a filtration/clarification step for effluent from the column, and high removal efficiency through higher surface contact with the media.

Having thus described several aspects of at least one embodiment of this disclosure, it is to be appreciated various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

1. A radial flow column comprising:
a fluid chamber having an inlet, an outlet, and a side wall;
an inner permeable retainer positioned in the fluid chamber;
an outer permeable retainer positioned in the fluid chamber spaced apart from and surrounding the inner permeable retainer;
a media bed compartment formed between the inner permeable retainer and the outer permeable retainer;
to a media bed comprising zero-valent iron disposed within the media bed compartment; and
an adjustable element biased into the media bed compartment and configured to maintain a predetermined packing density of the media bed.

2. The radial flow column of claim 1, wherein the inner permeable retainer and the outer permeable retainer are concentric.

3. The radial flow column of claim 1, further comprising an intermediate permeable retainer spaced apart from and surrounding the inner permeable retainer and spaced apart from and surrounded by the outer permeable retainer.

4. The radial flow column of claim 1, further comprising an inner flow chamber defined by an inner wall of the inner permeable retainer and having a first inlet at a first end of the inner flow chamber and a second inlet at a second end of the inner flow chamber.

5. The radial flow column of claim 1, wherein the adjustable element is an inflatable bladder.

6. The radial flow column of claim 1, wherein the adjustable element is a resiliently biased plunger.

7. The radial flow column of claim 1, wherein the zero-valent iron is in the form of a powder.

8. The radial flow column of claim 7, wherein the zero-valent iron powder has a particle size of less than about 100 μm.

9. The radial flow column of claim 7, wherein particles of the zero-valent iron powder are coated.

10. The radial flow column of claim 9, wherein particles of the zero-valent iron powder are coated with an iron-containing material.

11. The radial flow column of claim 10, wherein particles of the zero-valent iron powder are coated with an oxide of iron.

12. The radial flow column of claim 10, wherein particles of the zero-valent iron powder are coated with magnetite.

13. The radial flow column of claim 1, wherein the media bed includes a first layer of media having a first composition and a second layer of media having a second composition different from the first composition.

14. The radial flow column of claim 13, wherein the first layer of media includes the zero-valent iron.

15. The radial flow column of claim 1, wherein the media bed includes a sorbent and a filtration aid.

16. A radial flow column comprising:
a fluid chamber having a side wall;
a first inner permeable retainer;
a first outer permeable retainer surrounding the first inner permeable retainer and spaced apart from the first inner permeable retainer;
a first media bed compartment formed between the first inner permeable retainer and the first outer permeable retainer;
a second inner permeable retainer;
a second outer permeable retainer surrounding the second inner permeable retainer and spaced apart from the second inner permeable retainer;
a second media bed compartment formed between the second inner permeable retainer and the second outer permeable retainer and disposed axially inwardly of the first media bed compartment; and
a media bed comprising zero-valent iron disposed within one of the first media bed compartment and the second media bed compartment.

17. A method of facilitating removal of selenium from a contaminated water stream comprising:
providing a radial flow column including
a fluid chamber having a side wall,
an inner permeable retainer positioned in the fluid chamber,
an outer permeable retainer positioned in the fluid chamber spaced apart from and surrounding the inner permeable retainer and defining an outer chamber between the outer permeable retainer and the side wall,
a media bed compartment formed between the inner permeable retainer and the outer permeable retainer,
a media bed comprising zero-valent iron disposed within the media bed compartment,
an adjustable element biased into the media bed compartment and configured to maintain a predetermined packing density of the media bed, and
a flow chamber defined by the inner permeable retainer.

18. A method of treating feed water containing selenium, the method comprising:
providing a source of feed water containing selenium;
connecting the source of feed water to an inlet of a radial flow column including
a fluid chamber having a side wall,
an inner permeable retainer positioned in the fluid chamber,
an outer permeable retainer positioned in the fluid chamber spaced apart from and surrounding the inner permeable retainer and defining an outer chamber between the outer permeable retainer and the side wall,
a media bed compartment formed between the inner permeable retainer and the outer permeable retainer,
a media bed comprising zero-valent iron disposed in the media bed compartment,
an adjustable element biased into the media bed compartment and configured to maintain a predetermined packing density of the media bed, and
a fluid flow passageway defined by the inner permeable retainer;
passing the feed water from the inlet into the fluid flow passageway;
passing the feed water radially outwardly from the fluid flow passageway through the media bed and into the outer chamber to produce decontaminated water; and
removing the decontaminated water from the outer chamber.

19. The method of claim 18, wherein treating the feed water containing selenium comprises passing feed water including up to about 2200 μg/L of selenium through the radial flow column with a hydraulic residence time of less than about 0.25 hours and removing substantially all of the selenium from the feed water.

20. The method of claim 18, further comprising removing boron and nitrates from the feed water with the zero-valent iron.
